(19) United States
(12) Patent Application Publication
(10) Pub. No.: US 2013/0060388 A1
(43) Pub. Date: Mar. 7, 2013

(54) POSITIONER FAULT CHECKING METHOD

(71) Applicant: Toru KASHIMA, Tokyo (JP)

(72) Inventor: Toru KASHIMA, Tokyo (JP)

(73) Assignee: AZBIL CORPORATION, Tokyo (JP)

(21) Appl. No.: 13/600,206

(22) Filed: Aug. 30, 2012

(30) Foreign Application Priority Data
Sep. 2, 2011 (JP) 2011-191312

(51) Int. Cl. G05D 7/00

(52) U.S. Cl. 700/282

(57) ABSTRACT

Fault checking an EPM or a pilot relay, by an EPM driving signal Duty, into the EPM, and a nozzle back-pressure Pn, from the EPM, are sampled. A change speed vDuty (k) of the Duty (k) is calculated from the Duty (k) in the current cycle and the Duty (k−1) from the previous cycle, and a change speed vPn (k) for the Pn (k) is calculated from the Pn (k) for the current cycle and Pn (k−1) from the previous cycle. If both vDuty (k) and vPn (k) are small, then the weighting w1 (k) is defined as 1 (where it is defined as 0 otherwise), and with each sampling a fault check indicator value e1 (k) is calculated from a linear approximation formula F1 that indicates the steady-state input/output relationship, when operating properly, between the Duty (k), Pn (k), and EPM when w1 (k) is 1.

### CROSS-REFERENCE TO RELATED APPLICATION

The present application claims priority to Japanese Patent Application No. 2011-191312, filed Sep. 2, 2011. This application is incorporated herein by reference.

### FIELD OF TECHNOLOGY

The present invention relates to a method and device for checking for faults in a positioner for controlling the degree of opening of a regulator valve.

### BACKGROUND

Conventionally, in chemical plants, and like, positioners have been provided in regulator valves used in the flow rate processes thereof, to adjust the opening of regulator valves using the positioners. The positioner is provided with a calculating portion for calculating the difference between an opening setting value sent from a higher-level device and an actual opening value, fed back from the regulator valve, to generate an electric signal, as a control output, in accordance with this difference, an electro-pneumatic converting device for converting, into an air pressure signal, the control output generated by the calculating portion, and a pilot relay for amplifying this air pressure signal, converted by the electro-pneumatic converting device, and outputting it to an operating device of the regulator valve as an air pressure signal. (See, for example, Japanese Unexamined Utility Model Registration Application Publication S62-28118.)

FIG. 41 shows the flow of input/output signals in a system wherein a positioner is combined with a regulator valve. In this figure, 100 is the positioner and 200 is the regulator valve, where the positioner 100 is provided with an electrical module 1, an EPM (electro-pneumatic converter module) 2, and a pilot relay (an air pressure amplifying module) 3.

The electrical module 1 inputs the opening setting signal Iin and the opening X of the valve that is fed back from the regulator valve 200, to generate an EPM driving signal Duty as the control output. The EPM 2 inputs the EPM driving signal Duty from the electrical module 1 to convert the EPM driving signal Duty into a nozzle back pressure Pn. The pilot relay 3 inputs the nozzle back pressure Pn from the EPM 2 to generate an operating device pressure Po from the nozzle back pressure Pn. The regulator valve 200 inputs the operating device pressure Po from the positioner 100 to adjust the opening X of the valve in accordance with the operating device pressure Po.

FIG. 42 shows a diagram of a linear approximation of the steady-state input/output relationship between the individual modules within the positioner 100 and the regulator valve 200 when operating properly. FIG. 42 (a) shows the input/output relationship in the electrical module 1 (the relationship between the opening setting signal Iin and the EPM driving signal Duty); FIG. 42 (b) shows the input/output relationship in the EPM 2 (the relationship between the EPM driving signal Duty and the nozzle back pressure Pn); FIG. 42 (c) shows that the input/output relationship in the pilot relay 3 (the nozzle back pressure Pn and the operating device pressure Po); and FIG. 42 (d) shows the input/output relationship in the regulator valve 200 (the relationship between the operating device pressure Po and the degree of opening X). Note that this example is an example of a forward operating type (air-to-open) wherein the opening is larger in accordance with the amount of air that goes into the regulator valve 200.

Positioner Fault Checking and EPM Fault Checking Sometimes, in the positioner 100, blockages occur in the nozzle flapper of the EPM 2, or the fixed aperture becomes blocked. In such cases, the fault mode wherein there is a blockage in the nozzle flapper and the fault mode wherein the fixed aperture is blocked are manifested, as in FIG. 43, using the relationship between the EPM driving signal Duty and the nozzle back-pressure Pn, which are the input/output signals of the EPM 2. (See, for example Japanese Unexamined Patent Application Publication H07-110003 (“JP '003”).)

That is, when there is a blockage in the nozzle flapper, there can be a change in the direction of the nozzle back-pressure Pn going up (characteristic I′), relative to the characteristic I that shows the steady-state input/output relationship when operating properly, and when there is a blockage in the fixed aperture, there can be a change in the direction of the nozzle back-pressure Pn going down (characteristic I″). In these cases, the EPM driving signals Duty that are required in order to obtain the same nozzle back-pressure Pn can be different.

Because of these types of changes in the characteristics, it is possible to compare the relationship between the EPM driving signal Duty and the nozzle back-pressure Pn to what it is the time of proper operation, to check for a fault in the EPM 2 and to categorize the fault mode.

Pilot Relay Fault Checking In the positioner 100 there may be cases wherein the output air from the pilot relay leaks to the outside, or wherein output air is not exhausted from the inside. In these cases, the fault mode wherein output air leaks to the outside and fault mode wherein output air is not exhausted are manifested as in FIG. 44 using the relationship between the nozzle back-pressure Pn and the operating device pressure Po, which are the input/output signals of the pilot relay 3. (See, for example, JP '003.)

That is, when output air leaks to the outside, there is a change in the direction of the operating device pressure Po going down (characteristic II′), relative to the characteristic II that shows the steady-state input/output relationship when operating properly, and when the output air is not exhausted, there is a change in the direction of the operating device pressure Po going up (characteristic II″). In these cases, the nozzle back-pressures Pn required in order to obtain the same operating device pressure Po can be different.

It is possible to check for a fault in the pilot relay 3, and to categorize the fault mode, through comparing the relationship between the nozzle back-pressure Pn and the operating device pressure Po to what it is the time of proper operation.

However, in the positioner fault checking methods such as described above, in some cases it is not possible to check well for module faults when performing a module fault check of an EPM or pilot relay module, or the like, within a positioner during processing operations using data from during the processing operations.

For example, let us consider the case of a fault in the EPM illustrated in FIG. 43. In this case, when the EPM is moved quickly during a processing operation, then, due to a delay, the input/output relationship can deviate greatly from characteristic I (the steady-state model) that shows the steady-state input/output relationship when operating properly. (See FIG. 45.) Because of this, there can be an incorrect diagnosis that there is a fault in the EPM.

For example, let us consider the case of a fault in the pilot relay illustrated in FIG. 44. In this case, when the pilot relay is moved quickly during a processing operation, then, due to a delay, the input/output relationship can deviate greatly from characteristic II (the steady-state model) that shows the steady-state input/output relationship when operating properly. (See FIG. 46.) Because of this, there can be an incorrect diagnosis that there is a fault in the pilot relay.

Note that one may consider creating a dynamic model that includes the delay of the EPM or pilot relay, and performing the fault check based on the dynamic model that has been produced. However, this method requires an excessively large amount of work to produce highly accurate dynamic models, such as to produce the equations of motion (referencing, for example, Japanese Unexamined Patent Application Publication H07-77488 (“JP '488”)), and the amount of calculation overhead during operation can also be large, so the fault checks cannot be performed easily.

The examples of the present invention solve such problems, and the object thereof is to provide a method and device for checking for faults in positioners, able to perform fault checks of EPMs or pilot relays, like, in positioners easily and accurately during processing operations.

### SUMMARY

The examples of the present invention, in order to achieve such an object, can be a positioner fault checking method for performing fault checking on an applicable module wherein a specific module within a positioner that controls the opening of a regulator valve is the applicable module, having a step for sampling periodically an input signal into the applicable module and an output signal from the applicable module; a step for calculating a speed of change of the input signal that has been sampled; a step for calculating a speed of change of the output signal that has been sampled; a step for calculating a weighting depending on a combination of the speed of change of the input signal and the speed of change of the output signal, based on a weighting function that has been established in advance; and a step for performing fault checking of the applicable module based on the input signal and the output signal that have been sampled and on the weighting that has been calculated.

For example, in the present examples, if the applicable module is as electro-pneumatic converting device (EPM), then the EPM driving signal Duty (the EPM driving signal) is sampled at regular intervals as the input signal into the electro-pneumatic converting device, the nozzle back-pressure is sampled at regular intervals as the output signal from the EPM, and the speed of change of the EPM driving signal that has been sampled, and the speed of change of the nozzle back-pressure that has been sampled, are calculated. Given this, a weighting is calculated in accordance with a combination of the speed of change of the EPM driving signal and the speed of change of the nozzle back-pressure, based on weighting functions established in advance, and fault checks of the electro-pneumatic converting device are performed based on the EPM driving signals and nozzle back pressures, which have been sampled, and on the calculated weighting.

For example, in the present examples, the weighting is defined as 1 if the speed of change of the EPM driving signal and the speed of change of the nozzle back-pressure are both low, and the weighting is defined as 0 otherwise, and fault checking for the EPM is performed using the EPM driving signals and the nozzle back-pressure wherein the speeds of change are low. Doing this eliminates data that are very different from the characteristic that indicates the steady-state input/output relationship, when operating properly, during processing operation, making it possible to perform fault checking of the electro-pneumatic converting device.

In the present examples, if the applicable module is the pilot relay, then the nozzle back-pressure is sampled periodically as the input signal into the pilot relay, and the operating device pressure is sampled periodically as the output signal from the pilot relay. In this case as well, in the same manner as for the case of the electro-pneumatic converting device, described above, the weighting is set to 1 only if, for example, both the speed of change of the nozzle back-pressure and the speed of change of the operating device pressure are small, and the weighting is set to 0 otherwise, so that fault checking is performed on the pilot relay using only nozzle back-pressures and operating device pressures wherein the speeds of change are small, making it possible to exclude data, during processing operations, which would deviate greatly from the characteristics that shows the steady-state input/output relationships when operating properly, to perform the pilot relay fault checking.

While in the present examples the weighting is calculated in accordance with a combination of the speed of change of the input signal and the speed of change of the output signal, based on a weighting function that is established in advance, a weighting function may be used wherein the weighting is divided into a weighting component that is in accordance with the speed of change of the input signal and a weighting component that is in accordance with the speed of change of the output signal, and the weighting function may be one that combines the weighting component that is in accordance with the speed of change of the input signal and the weighting component that is in accordance with the speed of change of the output signal. Moreover, the weightings need not necessarily be values of 0 and 1, but instead they may be weightings that are larger as the speeds of change are smaller. Doing so makes it possible to use with priority the input/output signals wherein the speed of change is small (those which are moving slowly) to perform the fault checking for modules such as the EPM and the pilot relay.

In the present examples, the input signal into the applicable module and the output signal from the applicable module are sampled periodically, the speed of change of the input signal that is sampled and the speed of change of the output signal that is sampled are calculated, a weighting is calculated in accordance with a combination of the speed of change of the input signal and the speed of change of the output signal, based on a weighting function that is established in advance, and fault checking of the applicable module is performed based on the input signal and output signal that are sampled and on the weighting that is calculated, thus making it possible to perform fault checking of the module, such as an EPM or a pilot relay within a positioner, easily and accurately through eliminating the data that is greatly different from the characteristic that indicates the steady-state input/output relationship when operating properly.

### BRIEF EXPLANATION OF THE DRAWINGS

FIG. 1 is a diagram illustrating the structure of portions of a fault checking device performing fault checking on an EPM (an electro-pneumatic converting device) that applies the positioner fault checking method according to an example.

FIG. 2 is a diagram for explaining the method for calculating the steady-state input/output relationship, when operating properly, of the EPM in a situation wherein, for example, there is no EPM design specification.

FIG. 3 is a diagram illustrating one example of a weighting function used in the fault checking device.

FIG. 4 is a flowchart for the fault checking process performed by the CPU in the fault checking device according to the example.

FIG. 5 is a diagram illustrating the difference, on the Duty axis between the steady-state input/output relationship of the EPM, when operating properly, and data indicating the input/output relationship obtained in the present cycle.

FIG. 6 is a diagram illustrating the relationship between the first fault checking threshold value +e1ₜₕ₁ and the second fault checking threshold value −e1ₜₕ₂ in relation to the fault check indicator value e1 calculated by the fault checking device in an example.

FIG. 7 is a diagram illustrating another example of the weighting function used in the fault checking device according to the example.

FIG. 8 is a diagram illustrating the structure of the portions of a fault checking device for performing fault checking of a pilot relay wherein is applied a positioner fault checking method according to another example.

FIG. 9 is a diagram for explaining the method for calculating the steady-state input/output relationship, when operating properly, of the pilot relay in a situation wherein, for example, there is no pilot relay design specification.

FIG. 10 is a diagram illustrating one example of a weighting function used in the fault checking device according to the other example.

FIG. 11 is a flowchart for the fault checking process performed by the CPU in the fault checking device according to the second form of embodiment.

FIG. 12 is a diagram illustrating the difference, on the Pn axis between the steady-state input/output relationship of the pilot relay, when operating properly, and data indicating the input/output relationship obtained in the present cycle.

FIG. 13 is a diagram illustrating the relationship between the first fault checking threshold value +e2ₜₕ₁ and the second fault checking threshold value −e2ₜₕ₂ in relation to the fault check indicator value e2 calculated by the fault checking device in the other example.

FIG. 14 is a diagram illustrating another example of the weighting function used in the fault checking device according to the other example.

FIG. 15 is a diagram illustrating the change in the input/output relationship of the regulator valve when there is a fluid reactive force.

FIG. 16 is a diagram for explaining the hysteresis width of the input/output characteristic of the regulator valve that changes due to the frictional force.

FIG. 17 is a diagram illustrating the state wherein the input/output relationship deviates greatly from the steady-state input/output relationship, when operating properly, due to a delay when the regulator valve is moved quickly during processing operations.

FIG. 18 is a diagram illustrating the state wherein the calculated width of hysteresis of the input/output characteristic is large due to the delay when the regulator valve is moved quickly during processing operations.

FIG. 19 is a diagram illustrating the structure of components of a fault checking device (a reference example) for performing fault checking on a regulator valve, with a fluid reactive force as the fault check indicator value.

FIG. 20 is a diagram for explaining the method for calculating the steady-state input/output relationships when the regulator valve is operating properly when, for example, there are no regulator valve design specifications.

FIG. 21 is a diagram illustrating one example of a weighting function used in the fault checking device according to the reference example.

FIG. 22 is a flowchart for the fault checking process performed by the CPU in the fault checking device according to the reference example.

FIG. 23 is a diagram illustrating a subroutine for a process for calculating a weighting w3 (k) in the flowchart shown in FIG. 22.

FIG. 24 is a diagram illustrating a subroutine for a process for determining the category to which the degree of opening X (k) belongs in the flowchart shown in FIG. 22.

FIG. 25 is a diagram illustrating a subroutine for a process for updating the maximum value and minimum value of the operating device pressure in a category i in the flowchart shown in FIG. 22.

FIG. 26 is a diagram illustrating a subroutine of a process for calculating the fluid reactive force of each category i in the flowchart shown in FIG. 22.

FIG. 27 is a diagram illustrating a subroutine for a process for resetting the maximum value and minimum value for the operating device pressures for all of the categories i to their default values in the flowchart shown in FIG. 22.

FIG. 28 is a diagram illustrating separating data that is excluded and data that is extracted as valid data by the weighting w3 (k).

FIG. 29 is a diagram illustrating a situation wherein a difference is calculated, on the Po axis within data collected showing the input/output relationship (representative values) from the data, from when operating properly, in the category i.

FIG. 30 is a diagram showing a fluid reactive force that is calculated for each category i.

FIG. 31 is a diagram showing another example of a weighting function used in the fault checking device of the reference example.

FIG. 32 is a diagram illustrating the structures of the portions of a fault checking device (another reference example) for performing fault checking on a regulator valve wherein a hysteresis width is the fault checking indicator value.

FIG. 33 is a diagram for explaining the method for calculating the hysteresis width of the input/output characteristic, when the regulator valve is operating properly, in, for example, a case wherein there are no design specifications for the regulator valve.

FIG. 34 is a diagram illustrating one example of a weighting function used in the fault checking device in the other reference example.

FIG. 35 is a flowchart for the fault checking procedure that is performed by the CPU in the fault checking device according to the other reference example.

FIG. 36 is a diagram illustrating a subroutine for a process for calculating the hysteresis width for each category i in the flowchart shown in FIG. 35.

FIG. 37 is a diagram illustrating the state wherein the hysteresis width of the category i is calculated.

FIG. 38 is a diagram illustrating the width of hysteresis calculated for each category i.

FIG. 39 is a diagram illustrating the frictional force that is calculated for each category i.

FIG. 40 is a diagram illustrating the state wherein there is no large change in the width of hysteresis due to the fluid reactive force.

FIG. 41 is a diagram illustrating the flow of the input/output signals in a system that combines a positioner and a regulator valve.

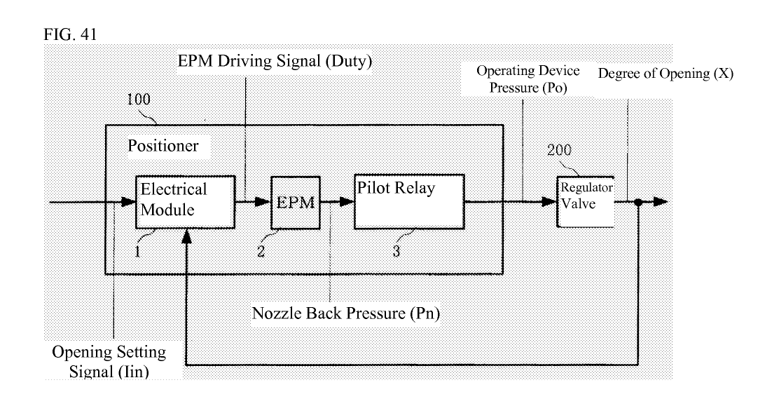

FIG. 42 is a diagram of a linear approximation of the steady-state input/output relationships, when operating properly, of the various modules of the positioner (the electrical module, the EPM, and the pilot relay) and the regulator valve.

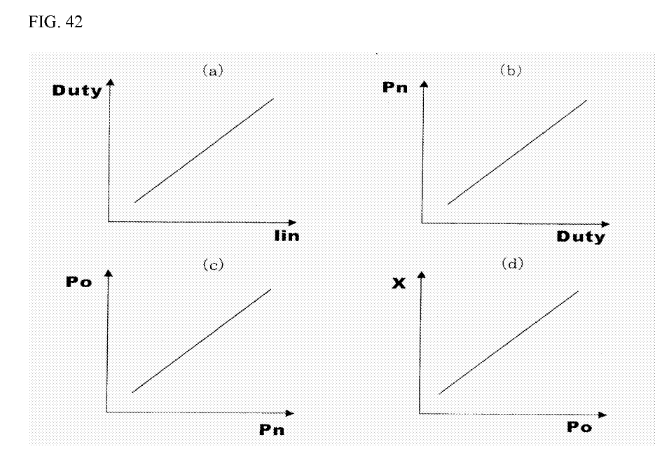

FIG. 43 is a diagram illustrating the change in the input/output relationship when there is a fault mode wherein there is a blockage in the nozzle flapper, and in the input/output relationship at the time of the fault mode wherein there is a blockage in the fixed aperture, relative to the steady state input/output relationship in the EPM when operating properly.

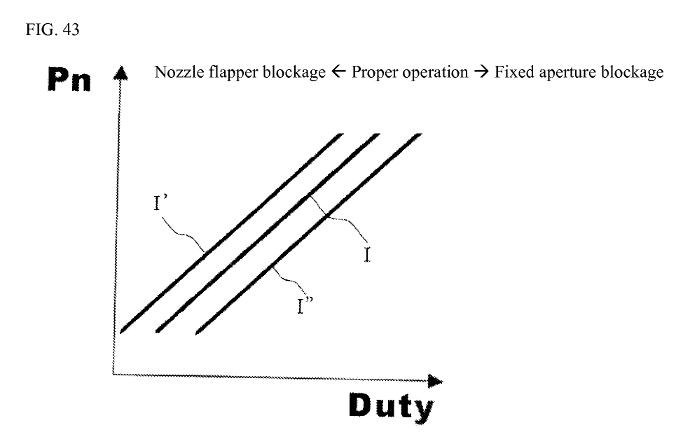

FIG. 44 is a diagram illustrating the change in the input/output relationship when there is a fault mode wherein air leaks to the outside, and in the input/output relationship when there is a fault mode wherein the output air is not exhausted, relative to the steady-state input/output relationship of a pilot relay when operating properly.

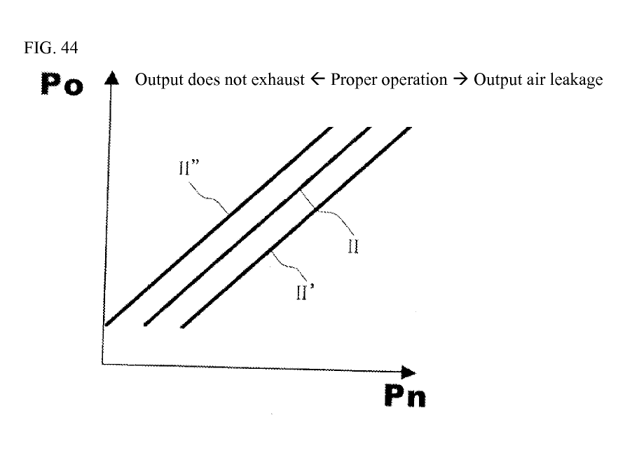

FIG. 45 is a diagram illustrating a state wherein, during processing operations, the input/output relationship deviates greatly from the steady-state input/output relationship when operating properly, due to the delay when the EPM is moved quickly.

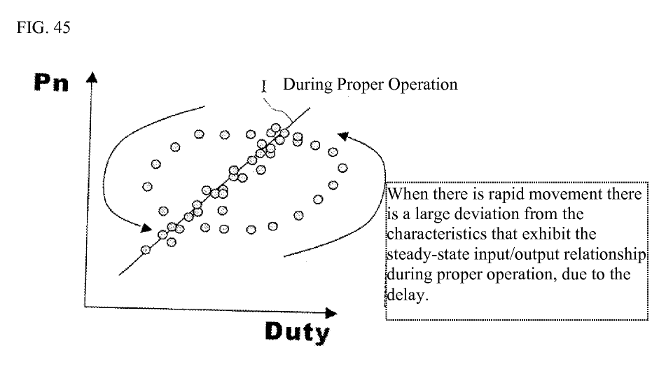

FIG. 46 is a diagram illustrating a state wherein, during processing operations, the input/output relationship deviates greatly from the steady-state input/output relationship when operating properly, due to the delay when the pilot relay is moved quickly.

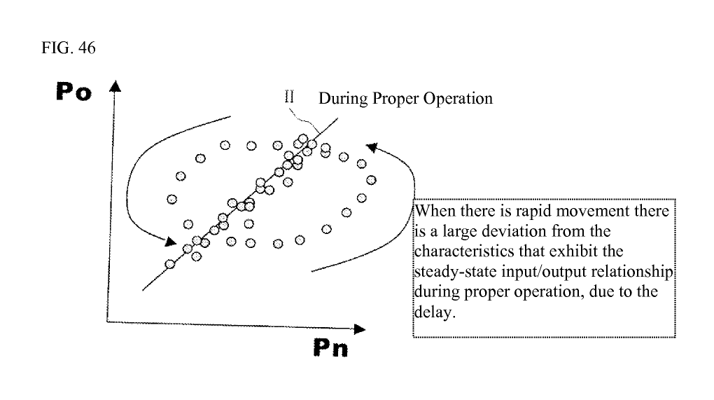

### DETAILED DESCRIPTION

Examples according to the present invention are explained in detail below, based on the drawings. Here, an example is explained wherein the applicable module is an EPM within a positioner, and fault checking is performed for the EPM, following which, as another example is explained wherein the applicable module is a pilot relay within the positioner, and fault checking is performed for the pilot relay. Moreover, finally, an example wherein fault checking is performed for a regulator valve can be explained as a reference example.

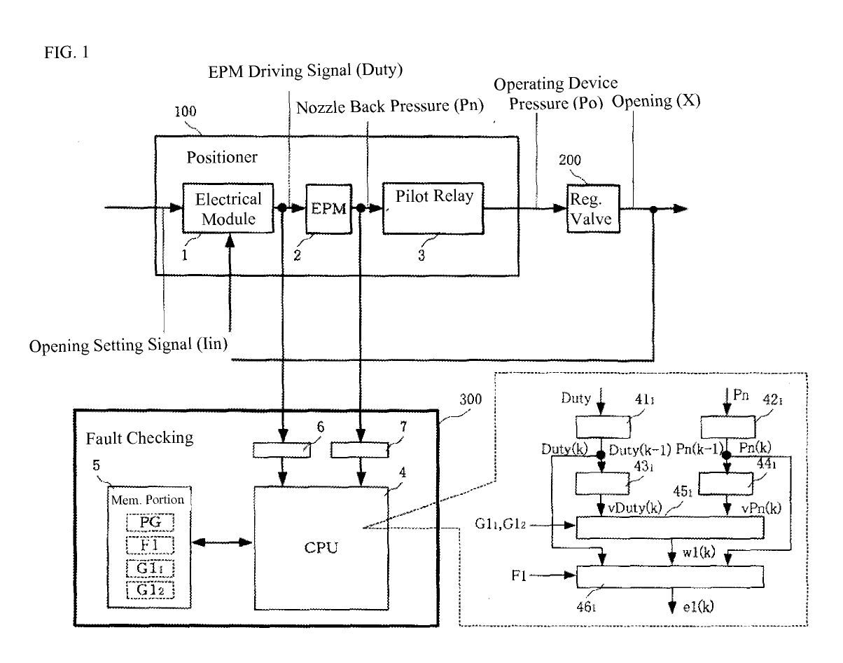

FIG. 1 illustrates the structure of portions of a fault checking device 300 for performing fault checking of an EPM 2. This fault checking device 300 includes a CPU 4, a memory portion 5 that is a ROM, a RAM, or the like, and interfaces 6 and 7. Note that this fault checking device 300 may be provided within a positioner 100, or may be provided outside of the positioner 100. FIG. 1 shows an example wherein it is provided on the outside of the positioner 100.

The EPM driving signal Duty that is the input signal into the EPM 2 is branched and inputted through the interface 6 into the CPU 4, and the nozzle back pressure Pn, which is the output signal from the EPM 2, is branched and inputted through the interface 7 into the CPU 4. The CPU 4 operates in accordance with a program PG that is stored in the memory portion 5.

In addition to the program PG referenced above, a linear approximation formula F1 that represents the steady-state input/output relationship, when operating properly, of the EPM 2 (the relationship between the EPM driving signal Duty and the nozzle back pressure Pn), and weighting functions G1₁ and G1₂, for calculating weightings in accordance with combinations of the speed of change of the EPM driving signal Duty and the speed of change of the nozzle back pressure Pn, are stored in the memory portion 5.

A Linear Approximation Formula F1. In the example, the linear approximation formula F1 that indicates the steady-state input/output relationship, when operating properly, in the EPM 2 is calculated from the design specification of the EPM 2. In this case, the linear approximation formula F1 is established as Pn=a1×Duty+b1 (where a1 and b1 are constants), and stored in the memory portion 5.

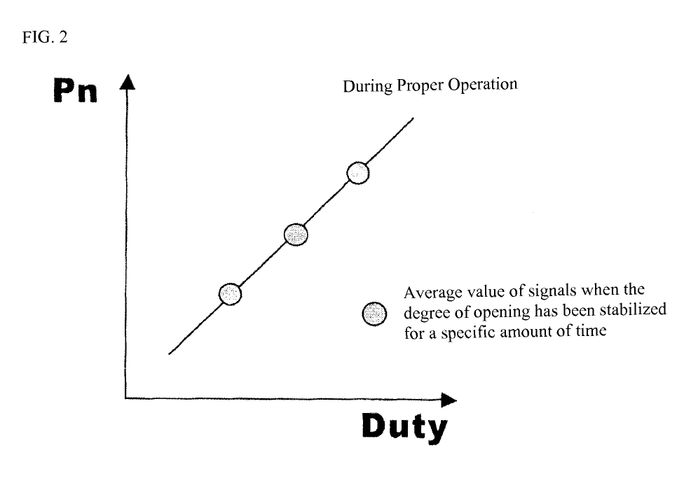

Note that when there is no design specification for the EPM 2, or the like, the average values of the EPM driving signals Duty and the nozzle back pressures Pn may be taken in a state wherein there are no blockages after a specific time interval of settling in states wherein the opening setting signal Iin is at 25%, 50%, and 75% (referencing FIG. 2), to perform a calculation from three points using the least squares method. In this case, that which is caused to be in the steady-state need not necessarily be three points. Moreover, a non-linear approximation (such as a non-linear regression equation such as multivariate approximation or a support vector machine, or the like), may be used instead of the linear approximation.

The Weighting Functions G1₁ and G1₂. In an example, in the weighting functions G1₁ and G1₂ for calculating the weightings in accordance with combinations of the speed of change of the EPM driving signal Duty and the speed of change of the nozzle back pressure Pn, G1₁ is established as a weighting function for obtaining a first weighting component wDuty from the speed of change of the EPM driving signal Duty, and G1₂ is established as a weighting function for obtaining a second weighting component wPn from the speed of change of the nozzle back pressure Pn. A weighting w1 is calculated in accordance with the combination of the speed of change of the EPM driving signal Duty and the speed of change of the nozzle back pressure Pn as w1=wDuty×wPn, as described below, from the weighting components wDuty and wPn obtained from the weighting functions G1₁ and G1₂.

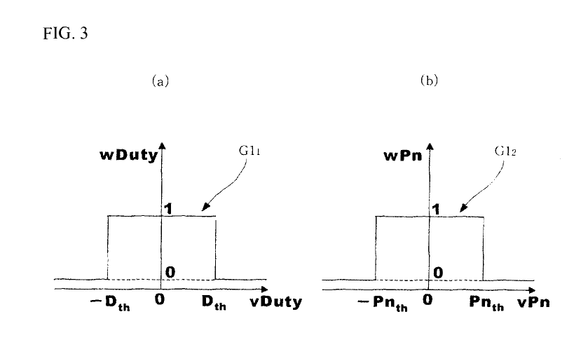

FIG. 3 (a) shows one example of the weighting function G1₁. In the first form of embodiment, as illustrated in FIG. 3 (a), the speed of change of the EPM driving signal Duty (%) is defined as vDuty (%/sec), and if the absolute value of this speed of change vDuty is no more than a threshold value Dth, then wDuty is 1, and otherwise it is 0.

FIG. 3 (b) shows one example of the weighting function G1₂. In the first form of embodiment, as illustrated in FIG. 3 (b), the speed of change of the nozzle back pressure Pn (kPa) is defined as vPn (kPa/sec), where, in a range wherein the absolute value of the speed of change vPn is no more than a threshold value Pnth, wPn is 1, and otherwise it is 0.

Here the threshold values Dth and Pnth are established with the tolerance value for the speed of change vDuty of the EPM driving signal Duty as Dth, and the speed of change vPn of the nozzle back pressure Pn that is produced by the delay when the EPM driving signal Duty is increased to Dth is established as Pnth. Note that the tolerance value Dth of the speed of change vDuty of the EPM driving signal Duty indicates a tolerance value for the speed of change vDuty wherein there is no risk of an incorrect diagnosis as a fault in the EPM due to this delay. The tolerance value Dth may be obtained through repeated experimentation.

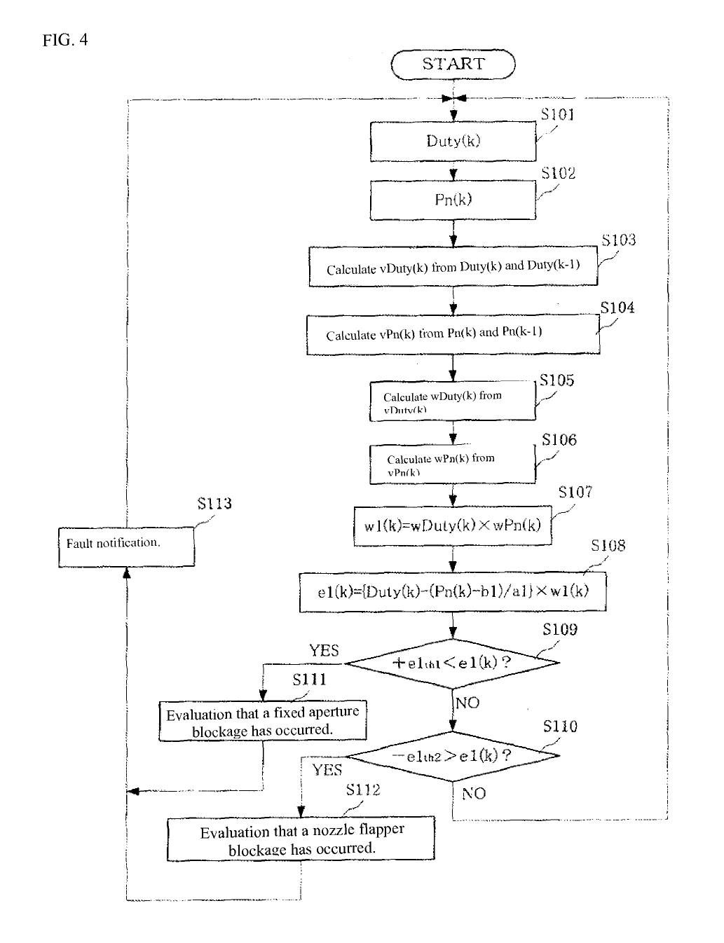

Fault Checks During Processing Operations. During processing operations, the CPU 4 periodically reads in the EPM driving signal Duty into the EPM 2 and the nozzle back pressure Pn from the EPM 2, to perform the fault checking on the EPM 2. FIG. 4 shows a flowchart for the fault checking process that is performed by the CPU 4.

The CPU 4 reads in the EPM driving signal Duty (k) and the nozzle back pressure Pn (k) at the current sampling interval (the k^{th} sampling interval) (Step S101 and S102), and calculates, as vDuty (k) the speed of change in the EPM driving signal Duty (k) from the current EPM driving signal Duty (k) and the previous EPM driving signal Duty (k−1) (Step S103). Moreover, it calculates, as vPn (k) the speed of change of the nozzle back pressure Pn (k) from the current nozzle back pressure Pn (k) and the previous nozzle back pressure Pn (k−1) (Step S104).

In this case, with the sampling interval defined as T (sec), vDuty (k) (%/sec) can be calculated through Equation (1), below, and vPn (k) (kPa/sec) can be calculated through Equation (2), below:

vDuty(k)=(Duty(k)−Duty(k−1))/T (1)

vPn(k)=(Pn(k)−Pn(k−1))/T (2)

The CPU 4 then calculates, from the speed of change vDuty (k) of the EPM driving signal Duty (k), a weighting component wDuty (k) that depends on the speed of change vDuty (k) following the weighting function G1₁ (FIG. 3 (a)) that is stored in the memory portion 5 (Step S105). At this time, if the absolute value of the speed of change vDuty (k) is no greater than the threshold value Dth, then wDuty (k) can equal 1, but if the absolute value of the speed of change vDuty (k) exceeds the threshold value Dth, then wDuty (k) can equal 0.

The CPU 4 also calculates, from the speed of change vPn (k) of the nozzle back pressure Pn (k), a weighting component wPn (k) that depends on the speed of change vPn (k) following the weighting function G1₂ (FIG. 3 (b)) that is stored in the memory portion 5 (Step S 106). In this case, if the absolute value of the speed of change vPn (k) is equal to or less than the threshold value Pnth, then wPn (k) can equal 1, but if the absolute value of the speed of change vPn (k) exceeds the threshold value Pnth, then wPn (k) can equal 0.

Following this, the CPU 4 calculates, from the weighting component wDuty (k), calculated in Step S105, and the weighting component wPn (k), calculated in Step S106, the weighting w1 (k) that depends on the combination of the speed of change vDuty (k) of the EPM driving signal Duty (k) and the speed of change vPn (k) of the nozzle back pressure Pn (k) as w1 (k)=wDuty (k)×wPn (k) (Step S107).

In this case, because w1 (k) is calculated as w1 (k)=wDuty (k)×wPn (k), the weighting w1 (k) can only be 1 when the conditions in the Conditional Equation (3), below, are satisfied, and the weighting w1 (k) can be 0 otherwise:

If(|VDuty(k)|≦Dth)AND(|Vpn(k)|≦pnth) (3)

That is, the weighting w1 (k) can be 1 only when the absolute value of the speed of change vDuty (k) of the EPM driving signal Duty (k) is no more than Dth and the absolute value of the speed of change vPn (k) of the nozzle back pressure Pn (k) is no more than Pnth, and otherwise the weighting w1 (k) can be 0.

Moreover, the CPU 4 substitutes, into Equation (4), below, the EPM driving signal Duty (k) obtained in Step S101, the nozzle back pressure Pn (k) obtained in Step S102, and the weighting w1 (k) obtained in Step S107, to calculate the fault check indicator value e1 (k) for the EPM 2 for the current sampling time interval (Step S108):

e1(k)={Duty(k)−(Pn(k)−b1)/a1}×w1(k) (4)

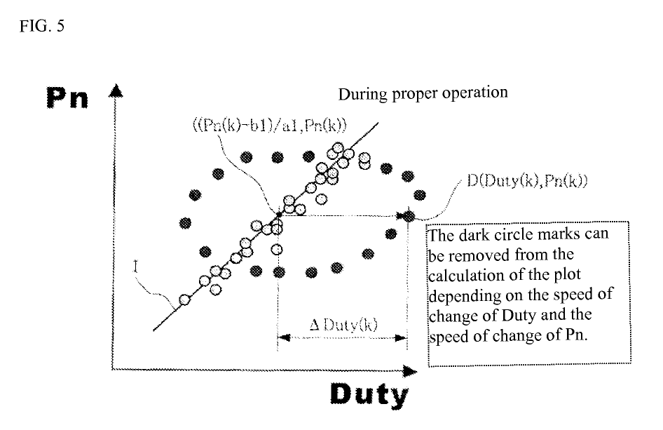

In Equation (4), the “Duty (k)−(Pn (k)−b1)/a1” indicates the difference, on the Duty axis, between the steady-state input/output relationship, when operating properly, of the EPM 2 that is indicated by the linear approximation formula F1 that is stored in the memory portion 5 and the data indicating the input/output relationship obtained in the present cycle. That is, if the steady-state input/output relationship, when operating properly, of the EPM 2 that is indicated by the linear approximation formula F1 is defined as characteristic I and the data indicating the input/output relationship obtained in the present cycle is defined as D (Duty (k), Pn (k)), then FIG. 5 shows the difference ΔDuty (k) between the EPM driving signal Duty when the nozzle back-pressure is Pn (k), in characteristic I, which equals (Pn (k)−b1)/a1, and the EPM driving signal Duty (k) obtained in the present cycle.

Moreover, in Equation (4), above, the “Duty (k)−(Pn (k)−b1)/a1” can be multiplied by w1 (k), that is, the difference ΔDuty (k) on the Duty axis can be multiplied by w1 (k), where ΔDuty (k) can be multiplied by w1 (k)=1 only when the absolute value of the speed of change vDuty (k) of the EPM driving signal Duty (k) is no more than a Dth and the absolute value of the speed of change vPn (k) of the nozzle back-pressure Pn (k) is no more than Pnth. In all other cases, ΔDuty (k) is multiplied by w1 (k)=0, and thus the fault check indicator value e1 (k) can be 0.

As a result, for the data plotted with the dark circle marks illustrated in FIG. 5, for example, the speed of change of the EPM driving signal Duty or of the nozzle back-pressure Pn is fast, and thus the fault check indicator value e1 (k) can be zero, so this data can be excluded from applicability in the fault checking.

After calculating the fault check indicator value e1 (k) in this way, the CPU 4 compares this calculated fault check indicator value e1 (k) with a first fault checking threshold value +e1ₜₕ₁ that has been set in advance (Step S109). If here the fault check indicator value e1 (k) is not greater than the first fault checking threshold value +e1ₜₕ₁ (Step S109: NO), then it is compared against a second fault checking threshold value −e1ₜₕ₂ (Step S110).

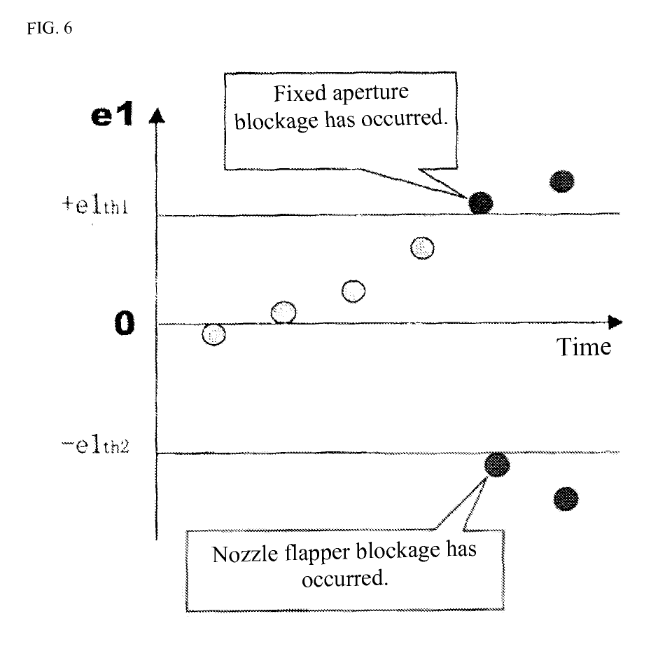

FIG. 6 shows the relationship between the first fault checking threshold value +e1ₜₕ₁ and the second fault checking threshold value −e1ₜₕ₂. The first fault checking threshold value +e1ₜₕ₁ is established as a threshold value in the positive direction, and the second fault checking threshold value −e1ₜₕ₂ is established as a threshold value in the negative direction.

If the fault check indicator value e1 (k) is greater than the first fault checking threshold value +e1ₜₕ₁ (Step S109: YES), then the CPU evaluates that a blockage has occurred in the fixed aperture (Step S111), and provides fault notification thereof (Step S113). If the fault check indicator value e1 (k) is less than the second fault checking threshold value −e1ₜₕ₂ (Step S110: YES), then the CPU evaluates that a blockage has occurred in the nozzle flap (Step S112), and provides fault notification thereof (Step S113).

Similarly, thereafter, each time the EPM driving signal Duty and the nozzle back-pressure Pn are sampled, a processing operation is repeated wherein the CPU 4 calculates the fault check indicator value e1 (k), and if the fault check indicator value e1 (k) is outside of the fault checking threshold value +e1ₜₕ₁ or −e1ₜₕ₂, provides fault notification and returns to Step S101, but if the fault check indicator value e1 (k) is within the fault checking threshold values +e1ₜₕ₁ and −e1ₜₕ₂, immediately returns to Step S101.

In this way, in this example, those data that deviate greatly from the characteristic I that represents the steady-state input/output relationship, when operating properly, during processing operations are eliminated, and the fault check of the EPM 2 is performed accurately using the simple steady-state model.

Note that while in this example the evaluation was that there is a fault if the fault check indicator value e1 is outside of the fault checking threshold value +e1ₜₕ₁ or the fault checking threshold value −e1ₜₕ₂ even once, instead the evaluation may be one wherein the evaluation is that there is a fault when, for example, the value is outside for a specific number of cycles in a row, or the fault notification may be canceled if the fault check indicator value e1 returns to be within the fault checking threshold value +e1ₜₕ₁ and the fault checking threshold value −e1ₜₕ₂. Moreover, the fault in the EPM 2 may be evaluated from, for example, the speed of change of the fault check indicator value e1, without necessarily using the fault checking threshold value +e1ₜₕ₁ or the fault checking threshold value −e1ₜₕ₂.

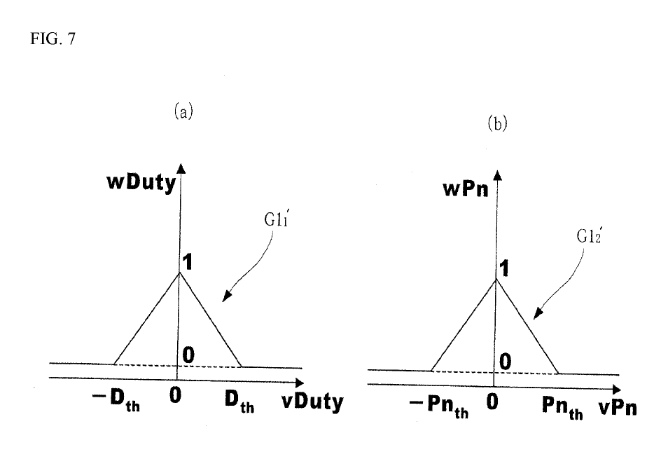

Moreover, while in this example weighting functions G1₁ and G1₂ were used for calculating weightings according to the combinations of the speed of change of the EPM driving signal Duty and the speed of change of the nozzle back pressure Pn, where rectangular weighting functions such as shown in FIG. 3 (a) and (b) were used, a triangular weighting function such as shown in FIG. 7 (a) and (b) may be used instead.

In the weighting function G1₁′, shown in FIG. 7 (a), if vDuty is 0, then wDuty is set to 1, but in the range wherein the absolute value of vDuty is no greater than the threshold value Dth, instead wDuty may gradually grow larger toward vDuty=0, where otherwise wDuty is 0. In the weighting function G1₂′ shown in FIG. 7 (b), wPn is 1 if vPn is 0, wherein a range wherein the absolute value of vPn is no larger than the threshold value Pnth, wPn may gradually grow larger towards vPn=0, and wPn is 0 otherwise.

Moreover, instead, in the weighting function G1₁′, for example, illustrated in FIG. 7 (a), wDuty may be made larger as vDuty gradually approaches vDuty=0 from positions that are further separated in the positive direction or negative direction, and in the weighting function G1₂′ illustrated in FIG. 7 (b), wPn may be made gradually larger as vPn approaches vPn=0 from positions that are further separated in the positive direction or the negative direction. The use of such weighting functions G1₁′ and G1₂′ cause the EPM driving signal Duty and the nozzle back pressure Pn wherein the speed of change is small (when moving slowly) to be used with priority when performing the fault checks on the EPM 2.

Moreover, the weighting function for calculating the weighting depending on the combination of the speed of change of the EPM driving signal Duty and the speed of change of the nozzle back pressure Pn need not necessarily be divided into weighting functions G1₁ and G1₂, but rather may be a single weighting function that combines G1₁ and G1₂ (a three-dimensional function). The same is true for the triangular weighting functions G1₁′ and G1₂′, which may be a single weighting function combining G1₁′ and G1₂′ (a three-dimensional function).

Moreover, while, in this example, a fault check indicator value e1 was calculated each time the EPM driving signal Duty and the nozzle back pressure Pn were sampled and the evaluation as to whether or not there was a fault was performed each time based on the calculated fault check indicator value e1, instead the fault check indicator values e1 may be accumulated over a specific time interval, and an overall fault evaluation may be performed using the accumulated fault check indicator values e1.

While in the fault checking device 300 according to the example the fault checking for the EPM 2 was performed as operating procedures of the CPU 4 following a program PG, when the functions performed by the operating procedures by the CPU 4 are expressed as blocks, the CPU 4 can be expressed as an EPM driving signal sampling portion 41₁ for sampling periodically the EPM driving signal Duty into the EPM 2, a nozzle back pressure sampling portion 42₁ for sampling periodically the nozzle back pressure Pn from the EPM 2, an EPM driving signal change speed calculating portion 43₁ for calculating the speed of change vDuty (k) of the EPM driving signal Duty (k) from the current EPM driving signal Duty (k) and the previous EPM driving signal Duty (k−1), sampled by the EPM driving signal sampling portion 41₁, a nozzle back pressure change speed calculating portion 44₁ for calculating the speed of change vPn (k) of the nozzle back pressure Pn (k) from the current nozzle back pressure Pn (k) and the previous nozzle back pressure Pn (k−1), sampled by the nozzle back pressure sampling portion 42₁, a weighting calculating portion 45₁ for calculating the weighting w1 (k) in accordance with the combination of the speed of change vDuty (k) of the EPM driving signal Duty (k) and the speed of change vPn (k) of the nozzle back pressure Pn (k), based on the weighting functions G1₁ and G1₂ that are stored in the memory portion 5, and a fault check indicator value calculating portion 46₁ for calculating the fault check indicator e1 (k) for the EPM 2 from the EPM driving signal Duty (k), sampled by the EPM driving signal sampling portion 41₁, the nozzle back pressure Pn (k), sampled by the nozzle back pressure sampling portion 42₁, the weighting w1 (k), calculated by the weighting calculating portion 45₁, and the linear approximation formula F1 that is stored in the memory portion 5.

Note that while in this example the speed of change vDuty (k) of the EPM driving signal Duty (k) was calculated from the current EPM driving signal Duty (k) and the previous EPM driving signal Duty (k−1) and the speed of change vPn (k) of the nozzle back pressure Pn (k) was calculated from the current nozzle back pressure Pn (k) and the previous nozzle back pressure Pn (k−1), instead it is possible to perform a linear approximation calculation using the least-squares method using a signal over a specific time interval from the past and then to use the rate of change of the slope of the approximation equation.

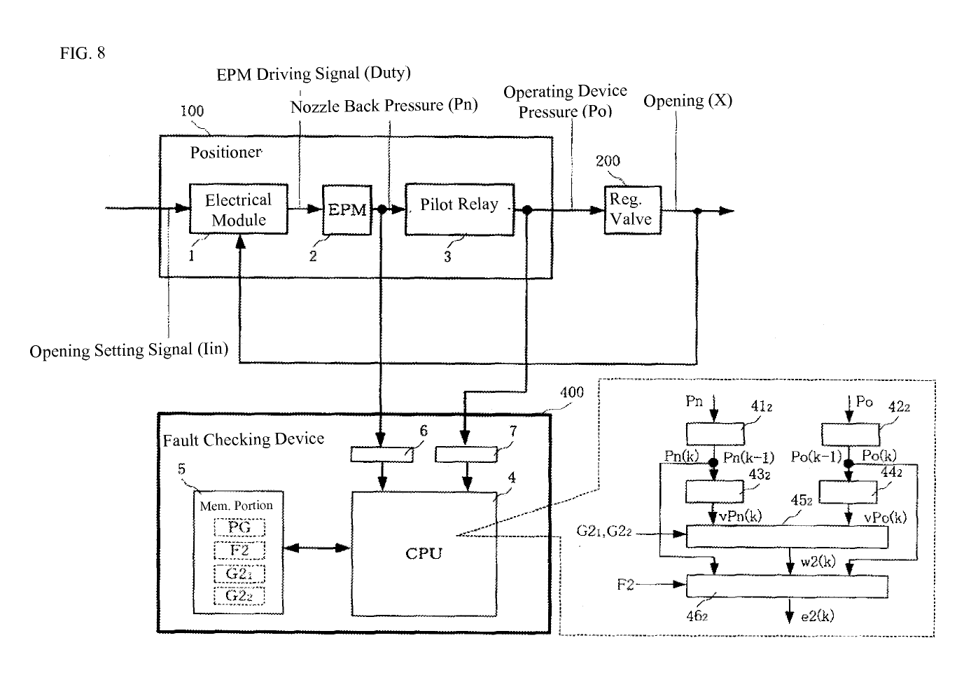

FIG. 8 shows the structure of certain components of a fault checking device 400 for performing fault checking for a pilot relay 3. In the fault checking device 400 as well, as with the example above, a CPU 4, a memory portion 5, such as a ROM or a RAM, and interfaces 6 and 7 are provided. Note that this fault checking device 400 may also be provided within the positioner 100, or may be provided outside of the positioner 100. FIG. 8 shows an example wherein it is provided outside of the positioner 100.

The nozzle back pressure Pn that is the input signal into the pilot relay 3 is branched and inputted through the interface 6 into the CPU 4, and the operating device pressure Po, which is the output signal from the pilot relay 3, is branched and inputted through the interface 7 into the CPU 4. The CPU 4 operates in accordance with a program PG that is stored in the memory portion 5.

In addition to the program PG referenced above, a linear approximation formula F2 that shows the steady-state input/output relationship (the relationship between the nozzle back pressure Pn and the operating device pressure Po), when operating properly, of the pilot relay 3, and weighting functions G2₁ and G2₂, for calculating weightings in accordance with combinations of the speed of change of the nozzle back pressure Pn and the speed of change of the operating device pressure Po, are stored in the memory portion 5.

In this other example, the linear approximation formula F2 that shows the steady-state input/output relationship when the pilot relay 3 is operating properly is calculated from the design specification of the pilot relay 3. In this case, the linear approximation formula F2 is established as Po=a1×Pn+b1 (where a1 and b1 are constants), and stored in the memory portion 5.

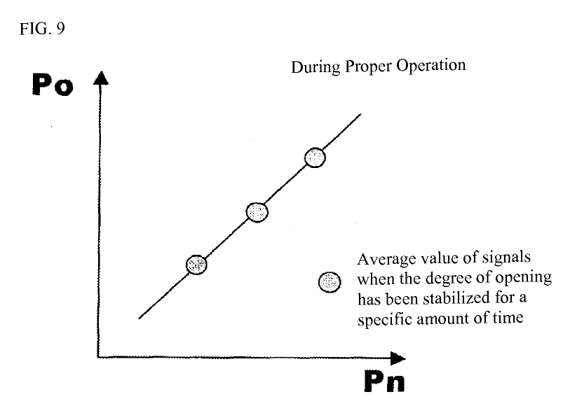

Note that when there is no design specification for the pilot relay 3, or the like, the average values of the nozzle back pressures Pn and operating device pressures Po may be taken in a state wherein there is no leakage after a specific time interval of settling in states wherein the opening setting signal Iin is at 25%, 50%, and 75% (referencing FIG. 9), to perform a calculation from three points using the least squares method. In this case, that which is caused to be in the steady-state need not necessarily be three points. Moreover, a non-linear approximation (such as a non-linear regression equation such as multivariate approximation or a support vector machine, or the like), may be used instead of the linear approximation.

In this other example, in the weighting functions G2₁ and G2₂ for calculating the weightings in accordance with combinations of the speed of change of the nozzle back pressure Pn and the speed of change of operating device pressure Po, G2₁ is established as a weighting function for obtaining a first weighting component wPn from the speed of change of the nozzle back pressure Pn, and G2₂ is established as a weighting function for obtaining a second weighting component wPo from the speed of change of the operating device pressure Po. A weighting w2 is calculated in accordance with the combination of the speed of change of the nozzle back pressure Pn and the speed of change of the operating device pressure Po as w2=wPn×wPo, as described below, from the weighting components wPn and wPo obtained from the weighting functions G2₁ and G2₂.

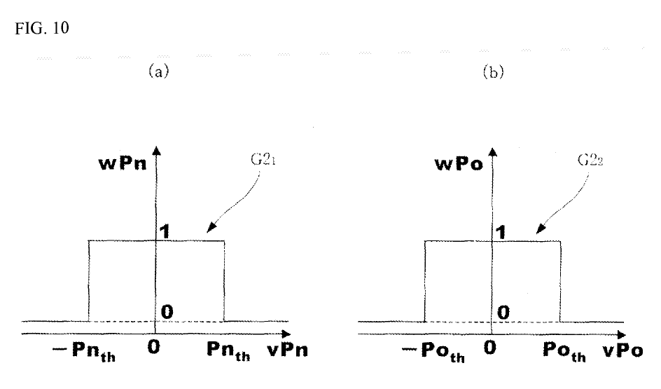

FIG. 10 (a) shows one example of the weighting function G2₁. In this example, as illustrated in FIG. 10 (a), the speed of change of the nozzle back pressure Pn (kPa) is defined as vPn (kPa/sec), and if the absolute value of this speed of change vPn is no more than a threshold value Pnth, then wPn is 1, and otherwise it is 0.

FIG. 10 (b) shows one example of the weighting function G2₂. In this example, as illustrated in FIG. 10 (b), the speed of change of the operating device pressure Po (kPa) is defined as vPo (kPa/sec), where, in a range wherein the absolute value of the speed of change vPo is no more than a threshold value Poth, wPo is 1, and otherwise it is 0.

Here the threshold values Pnth and Poth are established with the tolerance value for the speed of change vPn of the nozzle back pressure Pn as Pnth, and the speed of change vPo of the operating device pressure Po that is produced by the delay when the nozzle back pressure Pn is increased to Pnth is established as Poth. Note that the tolerance value Pnth of the speed of change vPn of the nozzle back pressure Pn indicates a tolerance value for the speed of change vPn wherein there is no risk of an incorrect diagnosis as a fault in the pilot relay due to this delay. The tolerance value Pnth may be obtained through repeated experimentation.

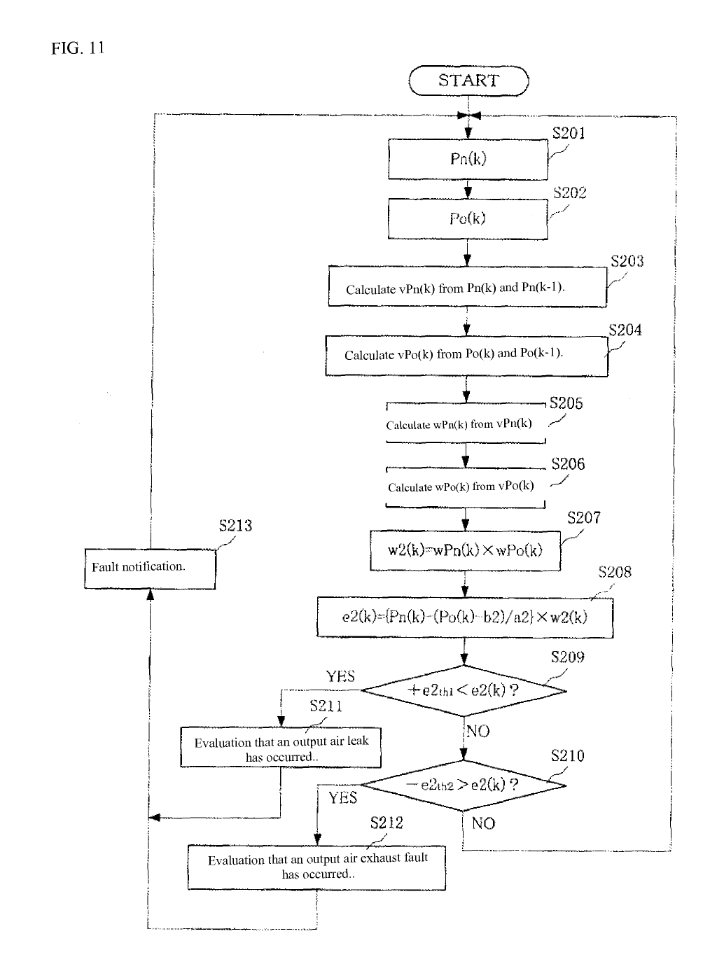

During processing operations, the CPU 4 periodically reads in the nozzle back pressure Pn into the pilot relay 3 and the operating device pressure Po from the pilot relay 3, to perform the fault checking on the pilot relay 3. FIG. 11 shows a flowchart for the fault checking process that is performed by the CPU 4.

The CPU 4 reads in the nozzle back pressure Pn (k) and the operating device pressure Po (k) at the current sampling interval (the k^{th} sampling interval) (Step S201 and S202), and calculates, as vPn (k) the speed of change in the nozzle back pressure Pn (k) from the current Nozzle back pressure Pn (k) and the previous Nozzle back pressure Pn (k−1) (Step S203). Moreover, it calculates, as vPo (k) the speed of change of the operating device pressure Po (k) from the current operating device pressure Po (k) and the previous operating device pressure Po (k−1) (Step S204).

In this case, with the sampling interval defined as T (sec), vPn (k) (kPa/sec) can be calculated through Equation (5), below, and vPo (k) (kPa/sec) can be calculated through Equation (6), below:

vPn(k)=(Pn(k)−Pn(k−1))/T (5)

vPo(k)=(Po(k)−Po(k−1))/T (6)

The CPU 4 then calculates, from the speed of change vPn (k) of the nozzle back pressure Pn (k), a weighting component wPn (k) that depends on the speed of change vPn (k) following the weighting function G2₁ (FIG. 10 (a)) that is stored in the memory portion 5 (Step S205). At this time, if the absolute value of the speed of change vPn (k) is no greater than the threshold value Pnth, then wPn (k) can equal 1, but if the absolute value of the speed of change vPn (k) exceeds the threshold value Pnth, then wPn (k) can equal 0.

The CPU 4 also calculates, from the speed of change vPo (k) of the operating device pressure Po (k), a weighting component wPo (k) that depends on the speed of change vPo (k) following the weighting function G2₂ (FIG. 10 (b) that is stored in the memory portion 5 (Step S206). In this case, if the absolute value of the speed of change vPo (k) is equal to or less than the threshold value Poth, then wPo (k) can equal 1, but if the absolute value of the speed of change vPo (k) exceeds the threshold value Poth, then wPo (k) can equal 0.

Following this, the CPU 4 calculates, from the weighting component wPn (k), calculated in Step S205, and the weighting component wPo (k), calculated in Step S206, the weighting w2 (k) that depends on the combination of the speed of change vPn (k) of the nozzle back pressure Pn (k) and the speed of change vPo (k) of the operating device pressure Po (k) as w2 (k)=wPn (k)×wPo (k) (Step S207).

In this case, because w2 (k) is calculated as w2 (k)=wPn (k)×wPo (k), the weighting w2 (k) can only be 1 when the conditions in the Conditional Equation (7), below, are satisfied, and the weighting w2 (k) can be 0 otherwise:

If(|vPn(k)|≦Pnth)AND(|vPo(k)|≦Poth) (7)

That is, the weighting w2 (k) can be 1 only when the absolute value of the speed of change vPn (k) of the nozzle back pressure Pn (k) is no more than Pnth and the absolute value of the speed of change vPo (k) of the operating device pressure Po (k) is no more than Poth, and otherwise the weighting w2 (k) can be 0.

Moreover, the CPU 4 substitutes, into Equation (8), below, the nozzle back pressure Pn (k) obtained in Step S201, the device operating pressure Po (k) obtained in Step S202, and the weighting w2 (k) obtained in Step S207, to calculate the fault check indicator value e2 (k) for the pilot relay 3 for the current sampling time interval (Step S208):

e2(k)={Pn(k)−(Po(k)−b2)/a2}×w2(k) (8)

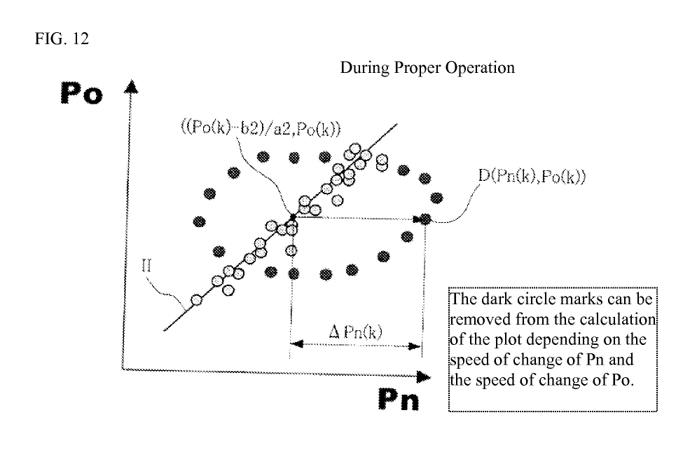

In Equation (8), the “Pn (k)−(Po (k)−b2)/a2” indicates the difference, on the Pn axis, between the steady-state input/output relationship, when operating properly, of the pilot relay 3 that is indicated by the linear approximation formula F2 that is stored in the memory portion 5 and the data indicating the input/output relationship obtained in the present cycle. That is, if the steady-state input/output relationship, when operating properly, of the pilot relay 3 that is indicated by the linear approximation formula F2 is defined as characteristic II and the data indicating the input/output relationship obtained in the present cycle is defined as D (Pn (k), Po (k)), then FIG. 12 shows the difference ΔPn (k) between the nozzle back pressure Pn when the operating device pressure is Po (k), in characteristic II, which equals (Po (k)−b2)/a2, and the nozzle back pressure Pn (k) obtained in the present cycle.

Moreover, in Equation (8), above, the “Pn (k)−(Po (k)−b2)/a2” can be multiplied by w2 (k), that is, the difference ΔPn (k) on the Pn axis can be multiplied by w2 (k), where ΔPn (k) can be multiplied by w2 (k)=1 only when the absolute value of the speed of change vPn (k) of the nozzle back pressure Pn (k) is no more than a Pnth and the absolute value of the speed of change vPo (k) of the operating device pressure Po (k) is no more than Poth. In all other cases, ΔPn (k) is multiplied by w2 (k)=0, and thus the fault check indicator value e2 (k) can be 0.

As a result, for the data plotted with the dark circle marks illustrated in FIG. 12, for example, the speed of change of the nozzle back pressure Pn or of the operating device pressure Po is fast, and thus the fault check indicator value e2 (k) can be zero, so this data can be excluded from applicability in the fault checking

After calculating the fault check indicator value e2 (k) in this way, the CPU 4 compares this calculated fault check indicator value e2 (k) with a first fault checking threshold value +e2ₜₕ₁ that has been set in advance (Step S209). If here the fault check indicator value e2 (k) is not greater than the first fault checking threshold value +e2ₜₕ₁ (Step S209: NO), then it is compared against a second fault checking threshold value −e2ₜₕ₂ (Step S210).

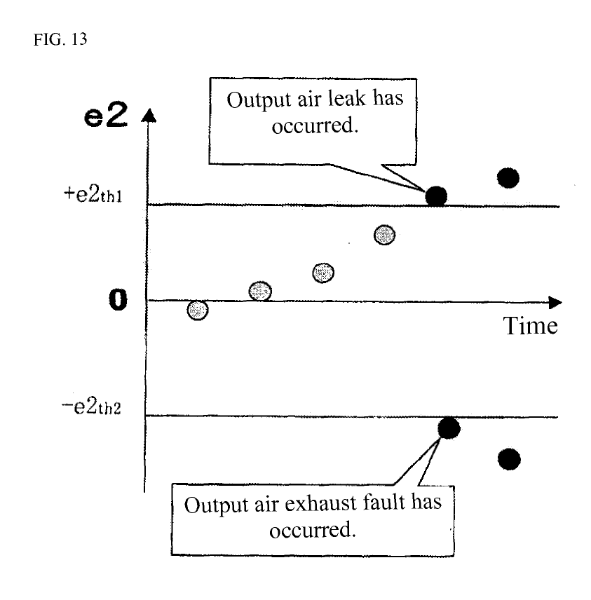

FIG. 13 shows the relationship between the first fault checking threshold value +e2ₜₕ₁ and the second fault checking threshold value −e2ₜₕ₂. The first fault checking threshold value +e2ₜₕ₁ is established as a threshold value in the positive direction, and the second fault checking threshold value −e2ₜₕ₂ is established as a threshold value in the negative direction.

If the fault check indicator value e2 (k) is greater than the first fault checking threshold value +e2ₜₕ₁ (Step S209: YES), then the CPU evaluates that a leak has occurred in the output air (Step S211), and provides fault notification thereof (Step S213). If the fault check indicator value e2 (k) is less than the second fault checking threshold value −e2ₜₕ₂ (Step S210: YES), then the CPU evaluates that an output air non-exhaust fault has occurred (Step S212), and provides fault notification thereof (Step S213).

Similarly, thereafter, each time the nozzle back pressure Pn and the operating device pressure Po are sampled, a processing operation is repeated wherein the CPU 4 calculates the fault check indicator value e2 (k), and if the fault check indicator value e2 (k) is outside of the fault checking threshold value +e2ₜₕ₁ or −e2ₜₕ₂, provides fault notification and returns to Step S201, but if the fault check indicator value e2 (k) is within the fault checking threshold values +e2ₜₕ₁ and −e2ₜₕ₂, immediately returns to Step S201.

In this way, in the present example, those data that deviate greatly from the characteristic II that represents the steady-state input/output relationship, when operating properly, during processing operations are eliminated, and the fault check of the pilot relay 3 is performed accurately using the simple steady-state model.

Note that while in the present example the evaluation was that there is a fault if the fault check indicator value e2 is outside of the fault checking threshold value +e2ₜₕ₁ or the fault checking threshold value −e2ₜₕ₂ even once, instead the evaluation may be one wherein the evaluation is that there is a fault when, for example, the value is outside for a specific number of cycles in a row, or the fault notification may be canceled if the fault check indicator value e2 returns to be within the fault checking threshold value +e2ₜₕ₁ and the fault checking threshold value −e2ₜₕ₂. Moreover, the fault in the pilot relay 3 may be evaluated from, for example, the speed of change of the fault check indicator value e2, without necessarily using the fault checking threshold value +e2ₜₕ₁ or the fault checking threshold value −e2ₜₕ₂.

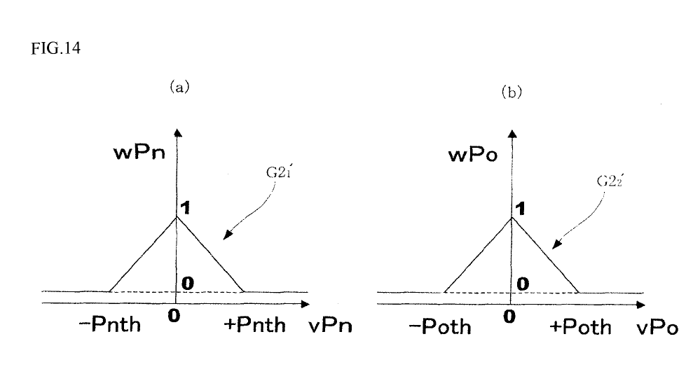

Moreover, while in the present example weighting, functions G2₁ and G2₂ were used for calculating weightings according to the combinations of the speed of change of the nozzle back pressure Pn and the speed of change of the operating device pressure Po, where rectangular weighting functions such as shown in FIG. 10 (a) and (b) were used, a triangular weighting function such as shown in FIG. 14 (a) and (b) may be used instead.

In the weighting function G2₁′, shown in FIG. 14 (a), if vPn is 0, then wPn is set to 1, but in the range wherein the absolute value of vPn is no greater than the threshold value Pnth, instead wPn may gradually grow larger toward vPn=0, where otherwise wPn is 0. In the weighting function G2₂′ shown in FIG. 14 (b), wPo is 1 if vPo is 0, wherein a range wherein the absolute value of vPo is no larger than the threshold value Poth, wPo may gradually grow larger towards vPo=0, and wPo is 0 otherwise.

Moreover, instead, in the weighting function G2₁′, for example, illustrated in FIG. 14 (a), wPn may be made larger as vPn gradually approaches vPn=0 from positions that are further separated in the positive direction or negative direction, and in the weighting function G2₂′ illustrated in FIG. 14 (b), wPo may be made gradually larger as vPo approaches vPo=0 from positions that are further separated in the positive direction or the negative direction. The use of such weighting functions G2₁′ and G2₂′ cause the nozzle back pressure Pn and the operating device pressure Po wherein the speed of change is small (when moving slowly) to be used with priority when performing the fault checks on the pilot relay 3.

Moreover, the weighting function for calculating the weighting depending on the combination of the speed of change of the nozzle back pressure Pn and the speed of change of the operating device pressure Po need not necessarily be divided into weighting functions G2₁ and G2₂, but rather may be a single weighting function that combines G2₁ and G2₂ (a three-dimensional function). The same is true for the triangular weighting functions G2₁′ and G2₂′, which may be a single weighting function combining G2₁′ and G2₂′ (a three-dimensional function).

Moreover, while, in the present example, a fault check indicator value e2 was calculated each time the nozzle back pressure Pn and the operating device pressure Po were sampled and the evaluation as to whether or not there was a fault was performed each time based on the calculated fault check indicator value e2, instead the fault check indicator values e2 may be accumulated over a specific time interval, and an overall fault evaluation may be performed using the accumulated fault check indicator values e2.

While in the fault checking device 400 according to the present example the fault checking for the pilot relay 3 was performed as operating procedures of the CPU 4 following a program PG, when the functions performed by the operating procedures by the CPU 4 are expressed as blocks, the CPU 4 can be expressed as a nozzle back pressure sampling portion 41₂ for sampling periodically the nozzle back pressure Pn into the pilot relay 3, an operating device pressure sampling portion 42₂ for sampling periodically the operating device pressure Po from the pilot relay 3, a nozzle back pressure change speed calculating portion 43₂ for calculating the speed of change vPn (k) of the nozzle back pressure Pn (k) from the current nozzle back pressure Pn (k) and the previous nozzle back pressure Pn (k−1), sampled by the nozzle back pressure sampling portion 41₂, an operating device pressure change speed calculating portion 44₂ for calculating the speed of change vPo (k) of the operating device pressure Po (k) from the current operating device pressure Po (k) and the previous operating device pressure Po (k−1), sampled by the operating device pressure sampling portion 42₂, a weighting calculating portion 45₂ for calculating the weighting w2 (k) in accordance with the combination of the speed of change vPn (k) of the nozzle back pressure Pn (k) and the speed of change vPo (k) of the operating device pressure Po (k), based on the weighting functions G2₁ and G2₂ that are stored in the memory portion 5, and a fault check indicator value calculating portion 46₂ for calculating the fault check indicator e2 (k) for the pilot relay 3 from the nozzle back pressure Pn (k), sampled by the nozzle back pressure sampling portion 41₂, the operating device pressure Po (k), sampled by the operating device pressure sampling portion 42₂, the weighting w2 (k), calculated by the weighting calculating portion 45₂, and the linear approximation formula F2 that is stored in the memory portion 5.

Note that while in an example the speed of change vPn (k) of the nozzle back pressure Pn (k) was calculated from the current Nozzle back pressure Pn (k) and the previous Nozzle back pressure Pn (k−1) and the speed of change vPo (k) of the operating device pressure Po (k) was calculated from the current operating device pressure Po (k) and the previous operating device pressure Po (k−1), instead it is possible to perform a linear approximation calculation using the least-squares method using a signal over a specific time interval from the past and then to use the rate of change of the slope of the approximation equation.

Here an example wherein fault checking is performed by calculating a fluid reactive force, as a fault check indicator value, from the input/output signals (the operating device pressure Po and the degree of opening X) of a regulator valve can be explained first as a first reference example, and an example wherein fault checking is performed by calculating a hysteresis width, as a fault check indicator value, from the input/output signals (the operating device pressure Po and the degree of opening X) can be explained as another reference example.

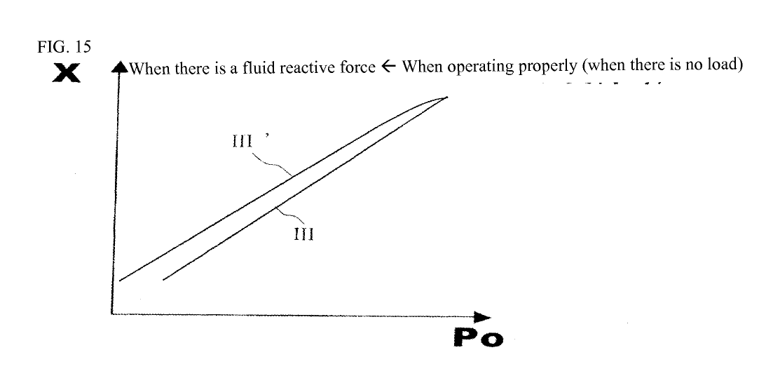

For fault checking in regulator valves, in the regulator valve 200 it is possible to detect the fluid reactive force that acts on the valve shaft (the force from the process fluid) from the relationship between the operating device pressure Po and the degree of opening X. FIG. 15 shows the change in the input/output relationship of the regulator valve 200 when there is a fluid reactive force. In this figure, III is a characteristic showing the steady-state input/output relationship when operating properly (the characteristic when there is no load), where this input/output relationship is modified by the occurrence of the fluid reactive force so to be as shown by characteristic III′.

When there is no load, the relationship between the operating device pressure Po and the degree of opening X exhibits a balance between the spring force and the force of the air pressure. When a fluid reactive force is produced, that balance is disrupted. Consequently, it is possible to detect a difference in the operating device pressure Po by comparing to the state wherein no reactive force is produced (when there is no load). It is possible to detect fluid pressures outside of the use range through monitoring this difference.

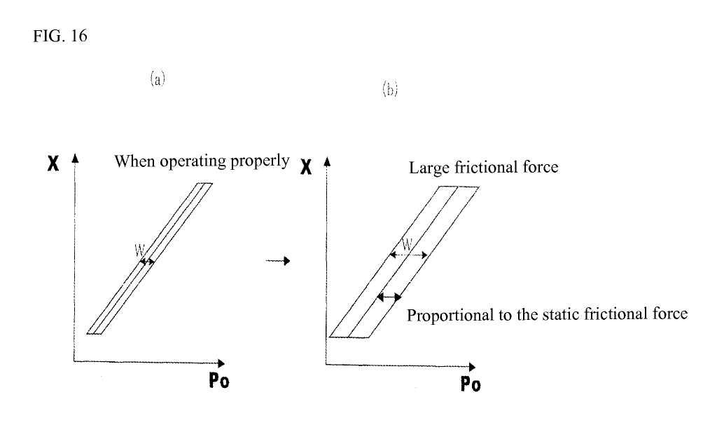

Moreover, it is possible to detect aberrations in the frictional force that acts on the valve shaft from the relationship between the operating device pressure Po and the degree of opening X. (See, for example, Japanese Translation of PCT International Application 2006-520038 and Japanese Translation of PCT International Application 2005-538462.) FIG. 16 (a) shows the hysteresis characteristics of the input/output relationship between the operating device pressure Po and the degree of opening X when operating properly. The input/output relationship can be different when the operating device pressure Po changes in the rising direction and when it changes in the falling direction, producing a hysteresis width W between the characteristic in the rising direction and the characteristic in the falling direction. As shown in FIG. 16 (b), this hysteresis width W can vary depending on the frictional force. Consequently, it is possible to check for a fault through comparing with the hysteresis width W from a time of proper operation. Note that multiplying one half of the hysteresis width W by the operating device diaphragm surface area produces the static frictional force, where this static frictional force may also be used as an indicator value.

However, when performing fault checking of the regulator valve using data from the processing operation during processing operations, in some cases it is not possible to check well for faults in the regulator valve.

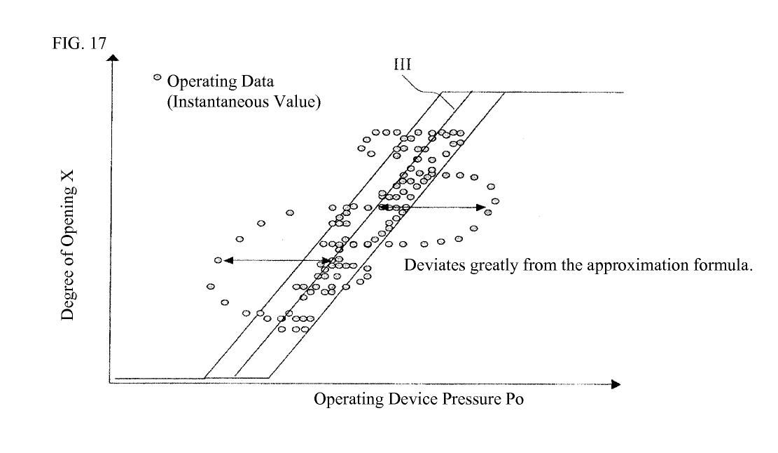

For example, let us consider the case of a fault (a large fluid reactive force) in the regulator valve illustrated in FIG. 15. In this case, when the regulator valve is moved quickly during a processing operation, then, due to a delay, the input/output relationship can deviate greatly from characteristic III (the steady-state model) that shows the steady-state input/output relationship when operating properly. (See FIG. 17.) Because of this, there can be an incorrect diagnosis that there is a fault in the regulator valve.

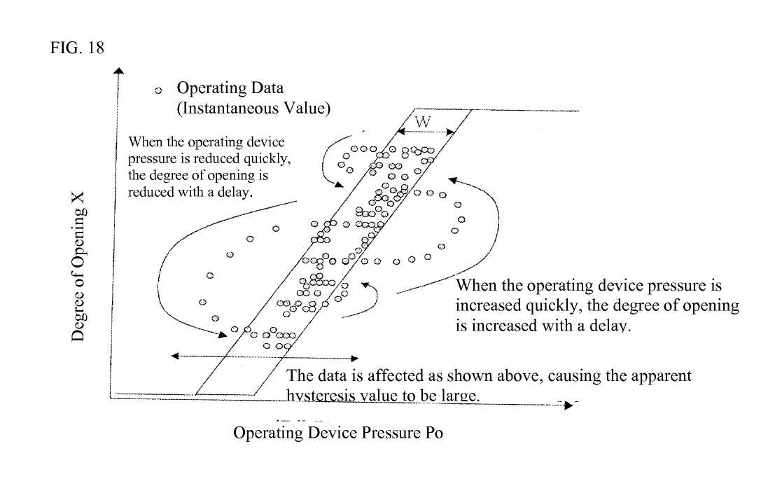

Moreover, let us consider a fault (a large frictional force) in the regulator valve, in FIG. 16. In this case, with the technology set forth in JP '003 and JP '488, data can also be used wherein the degree of opening X and/or the operating device pressure Po is moved rapidly. When such data becomes large, the hysteresis width W that is calculated becomes large, even if there is actually no change in the frictional force. (See FIG. 18.) Because of this, there can be an incorrect diagnosis that there is a fault in the regulator valve.

Note that one may consider creating a dynamic model that includes the delay of the regulator valve, and performing the fault check based on the dynamic model that has been produced. However, this method requires an excessively large amount of work to produce highly accurate dynamic models, such as to produce the equations of motion (referencing, for example, JP '488), and the amount of calculation overhead during operation can also be large, so the fault checks cannot be performed easily.

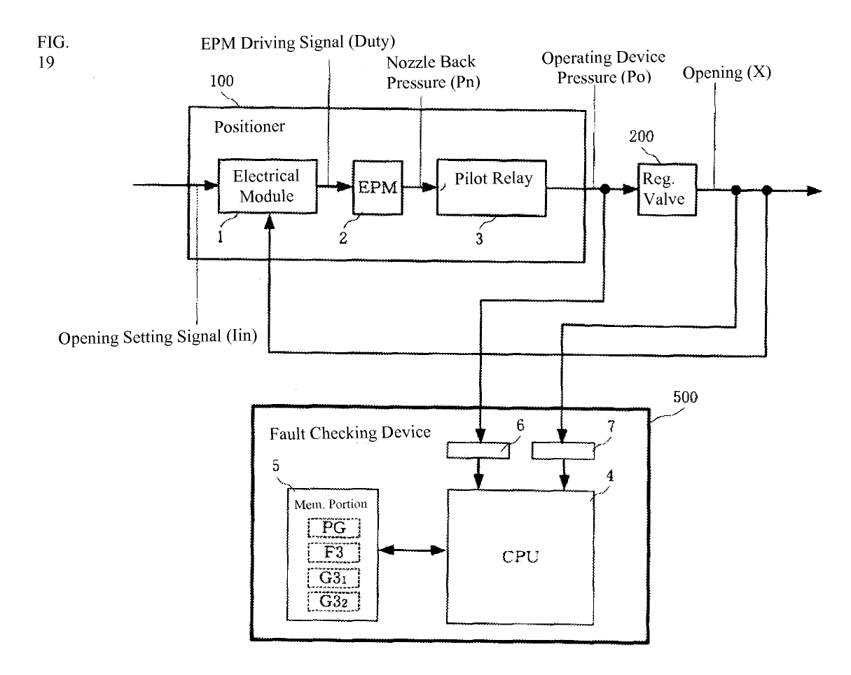

A reference example is described below. FIG. 19 shows the structure of the critical portions of a fault checking device 500 for performing a fault check of a regulator valve 200 with the flow reactive force as the fault check indicator value. This fault checking device 500 comprises a CPU 4, a memory portion 5 that is a ROM, a RAM, or the like, and interfaces 6 and 7.

The operating device pressure Po that is the input signal into the regulator valve 200 is branched and inputted through the interface 6 into the CPU 4, and the degree of opening X, which is the output from the regulator valve 200, is branched and inputted through the interface 7 into the CPU 4. The CPU 4 operates in accordance with a program PG that is stored in the memory portion 5.

In addition to the program PG referenced above, a linear approximation formula F3 that represents the steady-state input/output relationship, when operating properly, of the regulator valve 200 (the relationship between the operating device pressure Po and the degree of opening X (when there is no load)), and weighting functions G3₁ and G3₂, for calculating weightings in accordance with combinations of the speed of change of the operating device pressure Po and the speed of change of the degree of opening X, are stored in the memory portion 5.

In this reference example, the linear approximation formula F3 that indicates the steady-state input/output relationship, when operating properly, in the regulator valve 200 is calculated from the design specification of the regulator valve 200. In this case, the linear approximation formula F3 wherein the degree of opening varies between 0 and 100% with a spring range between 80 and 240 kPa is established as X=a3×Po+b3 (where a3=0.625 and b3=−50), and stored in the memory portion 5.

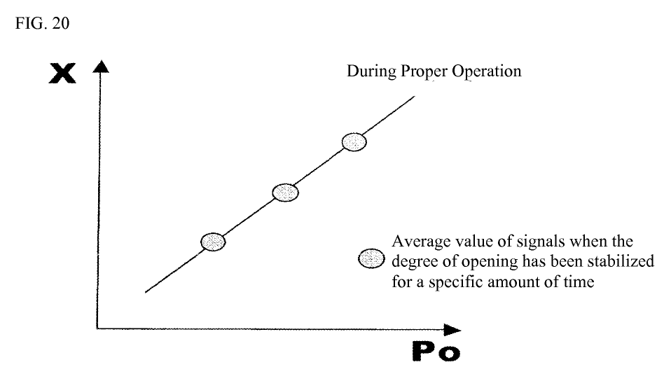

Note that when there is no design specification for the regulator valve 200, or the like, the average values of the operating device pressure Po and the degrees of opening X may be taken in a state wherein there are proper operations, such as immediately after maintenance, after a specific time interval of settling in states wherein the opening setting signal Iin is at 25%, 50%, and 75% (referencing FIG. 20), to perform a calculation from three points using the least squares method. In this case, that which is caused to be in the steady-state need not necessarily be three points. Moreover, a non-linear approximation (such as a non-linear regression equation such as multivariate approximation or a support vector machine, or the like), may be used instead of the linear approximation.

In this reference example, in the weighting functions G3₁ and G3₂ for calculating the weightings in accordance with combinations of the speed of change of the operating device pressure Po and the speed of change of the opening X, G3₁ is established as a weighting function for obtaining a first weighting component wPo from the speed of change of the operating device pressure Po, and G3₂ is established as a weighting function for obtaining a second weighting component wX from the speed of change of the degree of opening X. A weighting w3 is calculated in accordance with the combination of the speed of change of the operating device pressure Po and the speed of change of the degree of opening X as w3=wPo×wX, as described below, from the weighting components wPo and wX obtained from the weighting functions G3₁ and G3₂.

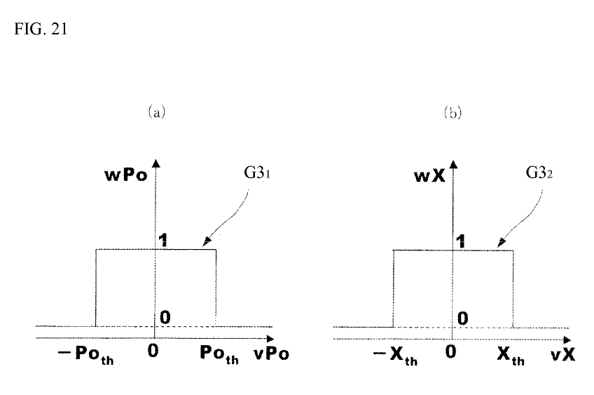

FIG. 21 (a) shows one example of the weighting function G3₁. In the first reference example, as illustrated in FIG. 21 (a), the speed of change of the operating device pressure Po (kPa) is defined as vPo (kPa/sec), and if the absolute value of this speed of change of vPo is no more than a threshold value Poth, then wPo is 1, and otherwise it is 0.

FIG. 21 (b) shows one example of the weighting function G3₂. In the first reference example, as illustrated in FIG. 21 (b), the speed of change of the degree of opening X (%) is defined as vX (%/sec), where, in a range wherein the absolute value of the speed of change vX is no more than a threshold value Xth, wX is 1, and otherwise it is 0.

Here the threshold values Poth and Xth are established with the tolerance value for the speed of change vPo of the operating device pressure Po as Poth, and the speed of change vX of the degree of opening X that is produced by the delay when the operating device pressure Po is increased to Poth is established as Xth. Note that the tolerance value Poth of the speed of change vPo of the operating device pressure Po indicates a tolerance value for the speed of change vPo wherein there is no risk of an incorrect diagnosis as a fault in the regulator valve due to this delay. The tolerance value Poth may be obtained through repeated experimentation.

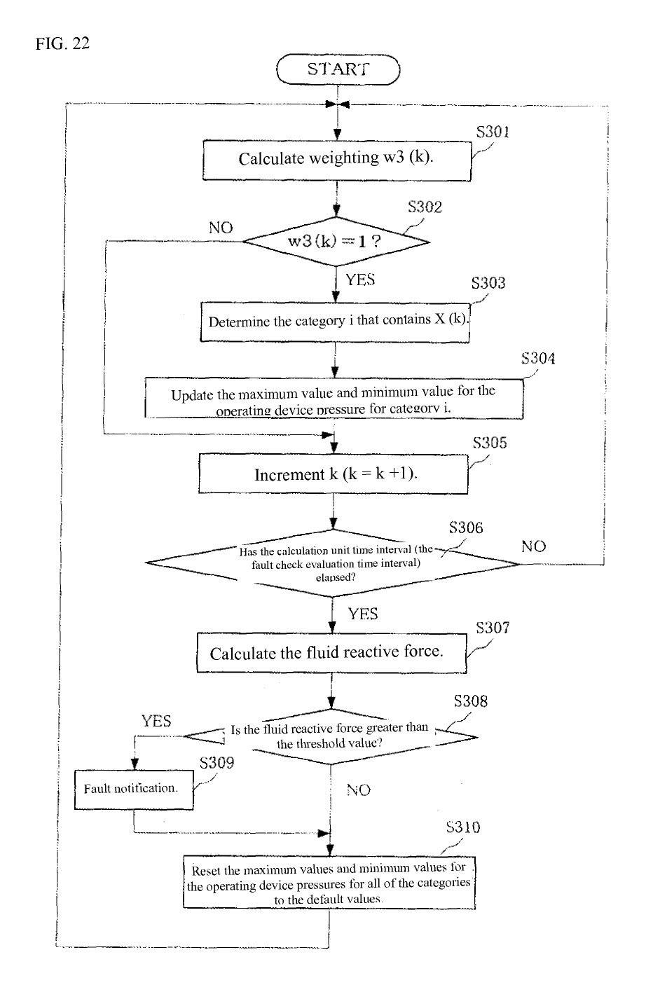

Fault checks during processing operations are described below. During processing operations, the CPU 4 periodically reads in the operating device pressure Po that is inputted into the regulator valve 200 and the degree of opening X that is outputted from the regulator valve 200, to perform the fault checking on the regulator valve 200. FIG. 22 shows a main flowchart for the fault checking process that is performed by the CPU 4.

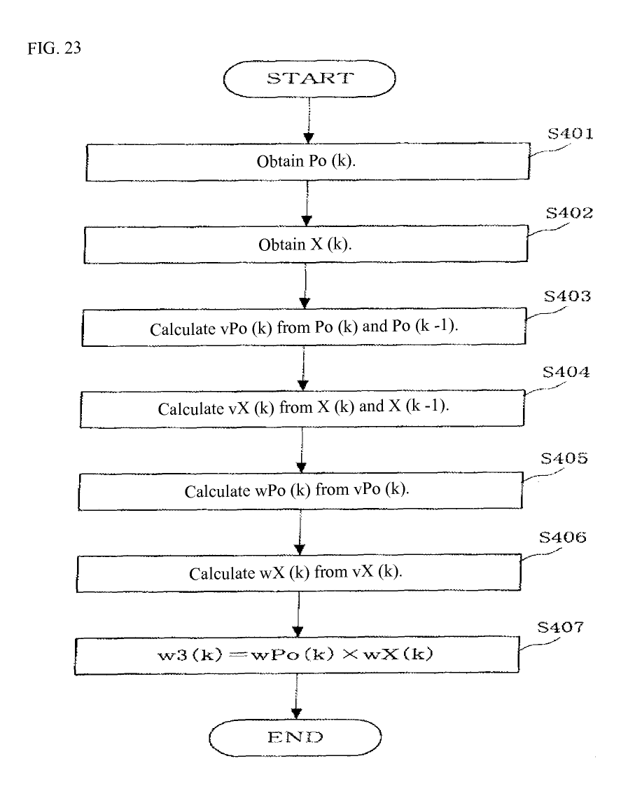

The CPU 4 reads in the operating device pressure Po (k) and the degree of opening X (k), calculates the speed of change of the operating device pressure Po and the speed of change of the degree of opening X that have been read in, and calculates a weighting w3 (k) in accordance with the combination of the speed of change of the operating device pressure Po and the speed of change of the degree of opening X that have been calculated (Step S301). The subroutine for the process that is performed in Step S301 is illustrated in FIG. 23.

The CPU 4 reads in the operating device pressure Po (k) and the degree of opening X (k) at the current sampling interval (the k^{th} sampling interval) (Step S401 and S402), and calculates, as vPo (k) the speed of change in the operating device pressure Po (k) from the current operating device pressure Po (k) and the previous operating device pressure Po (k−1) (Step S403). Moreover, it calculates, as vX (k) the speed of change of the degree of opening X (k) from the current degree of opening X (k) and the previous degree of opening X (k−1) (Step S404).

In this case, with the sampling interval defined as T (sec), vPo (k) (kPa/sec) can be calculated by Equation (9), below, and vX (k) (%/sec) can be calculated through Equation (10), below:

vPo(k)=(Po(k)−Po(k−1))/T (9)

vX(k)=(X(k)−X(k−1))/T (10)

The CPU 4 then calculates, from the speed of change vPo (k) of the operating device pressure Po (k), a weighting component wPo (k) that depends on the speed of change vPo (k) following the weighting function G3₁ (FIG. 21 (a)) that is stored in the memory portion 5 (Step S405). At this time, if the absolute value of the speed of change vPo (k) is no greater than the threshold value Poth, then wPo (k) can equal 1, but if the absolute value of the speed of change vPo (k) exceeds the threshold value Poth, then wPo (k) can equal 0.

The weighting component wX (k) that depends on the speed of change vX (k) is calculated from the speed of change vX (k) of the degree of opening X (k) following the weighting function G3₂ (FIG. 21 (b) that is stored in the memory portion 5 (Step S406). In this case, if the absolute value of the speed of change vX (k) is equal to or less than the threshold value Xth, then wX (k) can equal 1, but if the absolute value of the speed of change vX (k) exceeds the threshold value Xth, then wX (k) can equal 0.

Following this, the CPU 4 calculates, from the weighting component wPo (k), calculated in Step S405, and the weighting component wX (k), calculated in Step S406, the weighting w3 (k) that depends on the combination of the speed of change vPo (k) of the operating device pressure Po (k) and the speed of change vX (k) of the degree of opening X (k) as w3 (k)=wPo (k)×wX (k) (Step 407).

In this case, because w3 (k) is calculated as w3 (k)=wPo (k)×wX (k), the weighting w3 (k) can only be 1 when the conditions in the Conditional Equation (11), below, are satisfied, and the weighting w3 (k) can be 0 otherwise:

If(|vPo(k)|≦Poth)AND(|≦Xth) (11)

That is, the weighting w3 (k) can be 1 only when the absolute value of the speed of change vPo (k) of the operating device pressure Po (k) is no more than Poth and the absolute value of the speed of change vX (k) of the degree of opening X (k) is no more than Xth, and otherwise the weighting w3 (k) can be 0.

When w3 (k)=0. The CPU 4 then checks whether or not the weighting w3 (k) is 1 (Step S302 (FIG. 22)), where if the weighting w3 (k) is not 1 (Step S302: NO), then k is incremented (Step S305), and after confirming that a calculation unit time interval (fault check evaluation time interval) that has been set in advance has not elapsed (Step S306: NO), processing returns to Step S301. Note that in this example, the fault check evaluation time interval in Step S306 is one day.

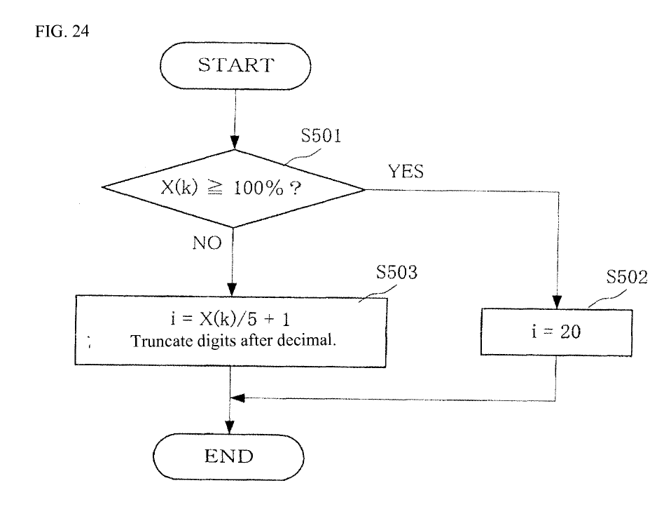

When w3 (k)=1. If the weighting w3 (k) is 1 (Step S302: YES), then the CPU 4 establishes the category i to which the degree of opening X (k) belongs (Step S303). FIG. 24 shows the subroutine for the process that is performed in Step S303.

The CPU 4 first checks whether or not the degree of opening X (k) is X (k)≧100% (Step S501). If here the degree of opening X (k) is equal to or greater than 100% (Step S501: YES), then the category i is set to i=20 (Step S502). If the degree of opening X (k) is not equal to or greater than 100% (Step S501: NO), then the category i is set to i=X (k)/5+1 (Step S503). Note that in the calculated value for i=X (k)/5+1, the digits after the decimal are truncated. As a result, if the opening X (k) is assumed to take a value between 0 and 100%, then the range of 0 through 100% is divided into 20 categories, each having a width of a 5% opening.

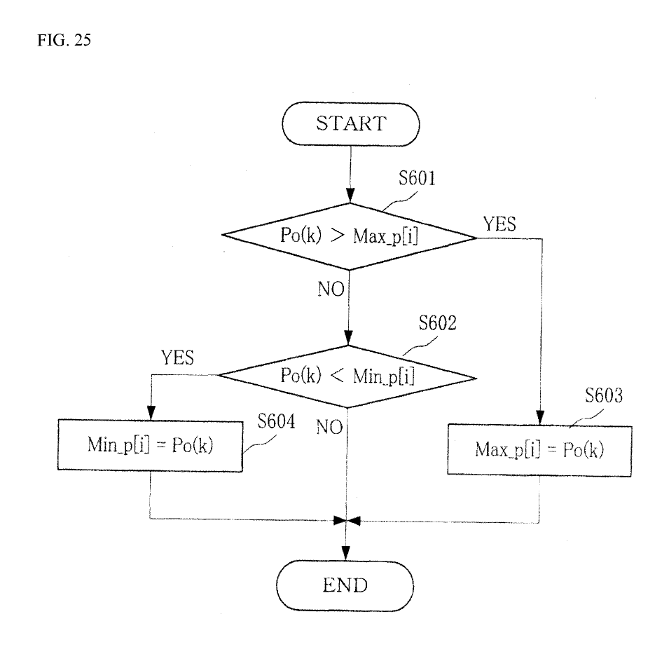

Following this, the CPU 4 updates the maximum value and minimum value for the operating device pressure Po in the category i to which the opening X (k) belongs (Step S304 (FIG. 22)). FIG. 25 shows the subroutine for the process that is performed in Step S304. Note that in this subroutine, Max_p (i) indicates the maximum value for the operating device pressure Po within the category i, and Min_p (i) indicates the minimum value for the operating device pressure Po in the category i. The default values for Max_p (i) and Min_p (i) are described below.

The CPU 4 first checks whether or not the operating device pressure Po (k) is Po (k)>Max_p (i) (Step S601). If here Po (k) is greater than Max_p (i) (Step S601: YES), then Po (k) is used as the new Max_p (i) (Step S603). If Po (k) is not greater than Max_p (i) (Step S601: NO), then a check is performed as to whether or not Po (k)<Min_p (i) (Step S602). If here Po (k) is less than Min_p (i) (Step S602: YES), then Po (k) is used as the new Min_p (i) (Step S604). If Po (k) is no more than Max_p (i) and no less than Min_p (i) (Step S602: NO), then neither Max_p (i) nor Min_p (i) is updated.

Given this, the CPU 4, after performing the processes for updating Max_p (i) and Min_p (i), increments k (Step S305 (FIG. 22)), and, upon confirming that the fault check evaluation time interval has not elapsed (Step S306: NO), returns to Step S301.

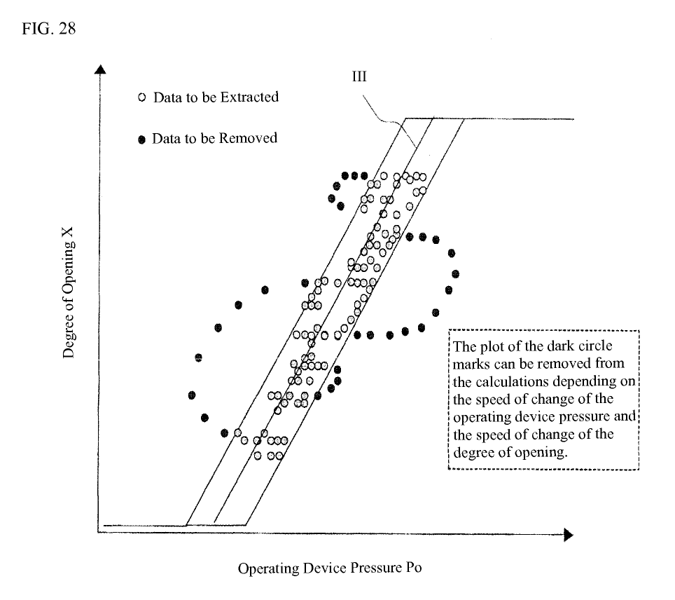

Through repeating Step S301 through S306 the operating device pressures Po (k) and the degrees of opening X (k) wherein the weighting w3 (k) is zero are excluded, and only those operating device pressures Po (k) and degrees of opening X (k) wherein the weighting w3 (k) is 1 can be extracted (referencing FIG. 28), where these extracted data are used as valid data (data subject to extraction), and a maximum value Max_p (i) and a minimum value Min_p (i) for the operating device pressures Po within the category i are calculated for each category i.

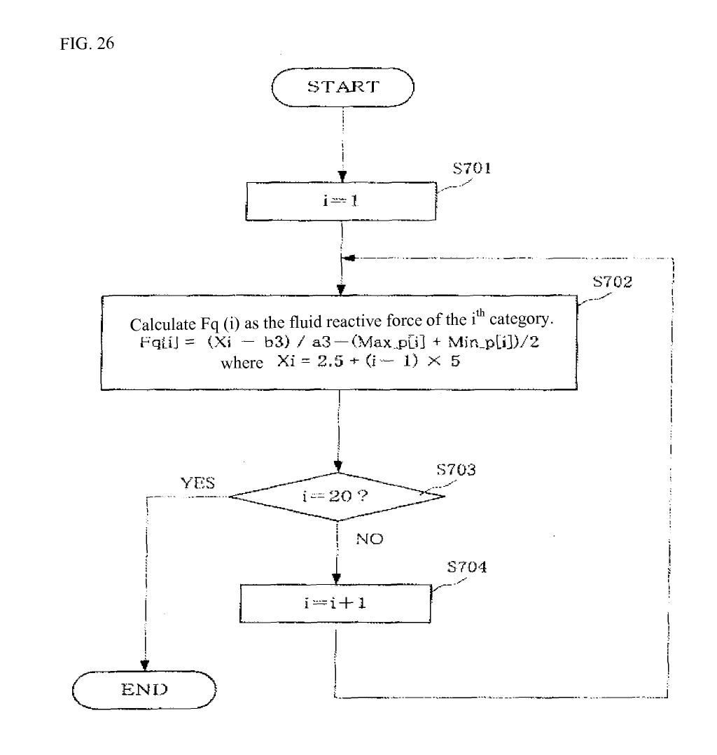

When the fault check evaluation time interval has expired (Step S306: YES), that is, when the incremented value of k in Step S305 indicates that the fault check evaluation time interval has expired, then the CPU 4 calculates the fluid reactive force in each category i as a fault check indicator value (Step S307). FIG. 26 shows the subroutine for the process that is performed in Step S307.

The CPU 4 first sets i=1 (Step S701). Given this, with Fq (i) defined as the fluid reactive force for the i=1 category, the maximum value Max_p (i) and the minimum value Min_p (i) for the operating device pressure Po in that category i are substituted into Equation (12), below, to calculate the fluid reactive force Fq (i) for the i=1 category (Step S702). Note that X i=2.5+(i−1)×5:

Fq(i)=(Xi−b3)/a3−(Max_{—}p(i)+Min_{—}p(i))/2 (12)

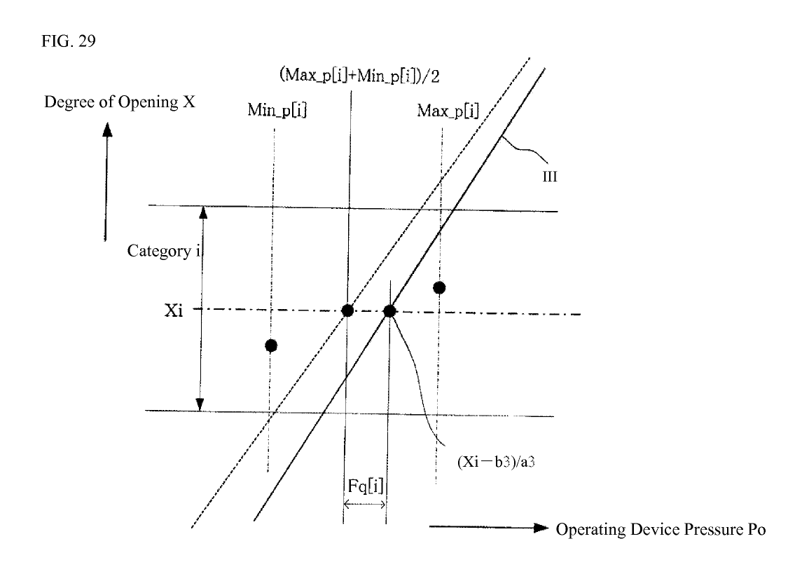

Equation (12), above, represents the difference, on the Po axis, between the steady-state input/output relationship, when operating properly, in the regulator valve 200, indicated by the linear approximation formula F3 that is stored in the memory portion 5, and the data (the substituted values) that indicate the input/output relationship gathered in category i. That is, the central value ((Max_p (i)+Min_p (i))/2) between the maximum value Max_p (i) and the minimum value Min_p (i) for the operating device pressure Po in category i is used as a representative value for the operating device pressure Po in category i, and the central value (Xi) for the range of degrees of opening in category i is used as a representative value for the degree of opening X in category i, and the difference between the representative value and the data when operating properly is shown on the Po axis (referencing FIG. 29). This difference is calculated as the fluid reactive force Fq (i) for category i. Note that Fq (i) is a pressure (kPa), but the units can be converted from a pressure (kPa) into a force (N) through multiplying by the surface area of the diaphragm of the operating device (m²)×10⁻³.

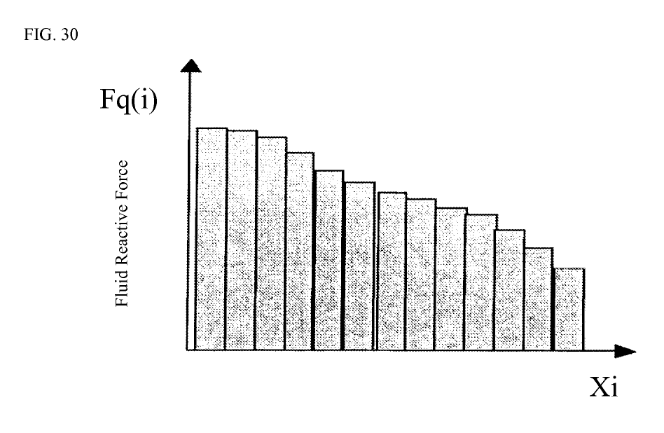

After calculating the fluid reactive force Fq (i) for category i=1, the CPU 4 repeats the processing procedures of Step S701 through S704 while incrementing i (Step S704) until i reaches 20 (Step S703: YES). Doing so causes the fluid reactive force (i) for category i to be calculated for each of the categories i (referencing FIG. 30).

Additionally, after calculating the fluid reactive forces Fq (i) for each category i, the CPU 4 then uses the fluid reactive forces Fq (i) calculated for each of the categories i as fault check indicator values and compares the fluid reactive forces Fq (i) to threshold values that have been established in advance (Step S308 (FIG. 22)), and if even one of the fluid reactive forces Fq (i) exceeds a threshold value (Step S308: YES), provides a fault notification (Step S309).

After the fault notification of Step S309, or in response to NO in Step S308, the CPU 4 resets all of the maximum values Max_p (i) and minimum values Min_p (i) for the operating device pressures Po in all of the categories i to the default values (Step S310), returns to the procedure of Step S301, and repeats the same operating procedures.

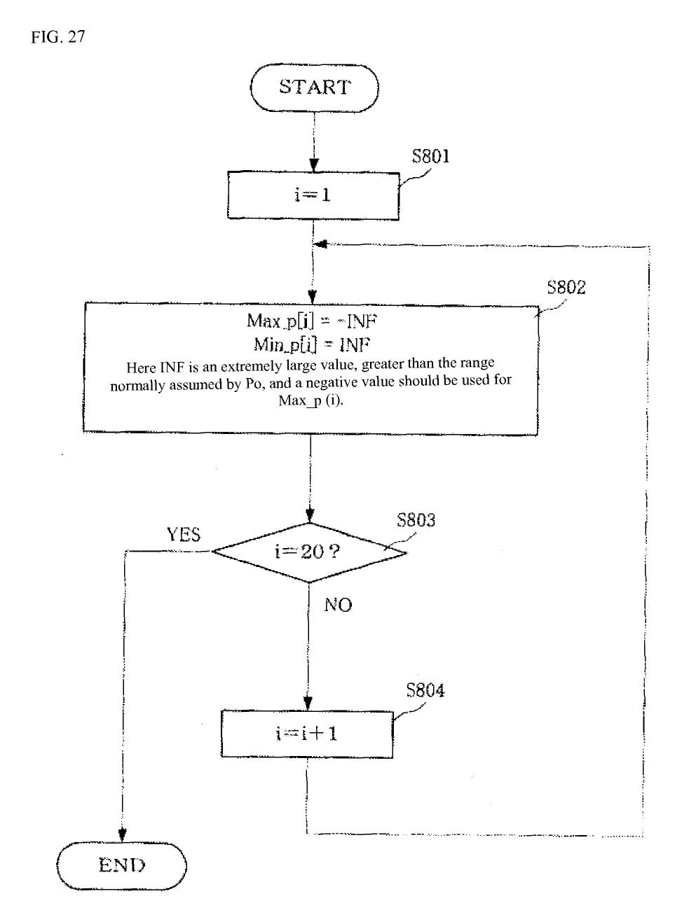

FIG. 27 illustrates the subroutine of the process that is performed in Step S310. The CPU 4 first sets i=1 (Step S801). It then sets Max_p (i)=−INF, and Min p (i)=INF. Here INF is an extremely large value (a positive value), in excess of a range that would normally be assumed by the operating device pressure Po. As a result, Min_p (i) can be set to a positive value (the default value) in excess of the range that would normally be assumed by the operating device pressure Po, and Max_p (i) is set to the negative value that is the inverse of Min_p (i) (the default value).

After setting Max_p (i) and the minimum value Min_p (i) for category i=1 to the default values, the CPU 4 repeats the processing operations of Step S801 through S804, while incrementing i (Step S804) until i=20 (Step S803: YES). As a result, Max_p (i) and the minimum value Min_p (i) for category i are set to the default values for all of the categories.

By setting Max_p (i) to −INF (a negative value) and the minimum value Min_p (i) to INF (a positive value) for the category i, for each category i, in Step S309 and then returning processing to Step S301, the values of Max_p (i) and Min_p (i) can be updated to Po (k), regardless of the value that arrives for the operating device pressure Po (k) when the updating procedure for Max_p (i) and the minimum value Min_p (i) is performed in Step S304.

At the point in time wherein the fault check evaluation time interval elapses, if Max_p (i) and/or Min_p (i) of the i^{th} category have not been updated even once, that is, if the default values remain, then the fluid reactive force calculation is not performed in Step S307, and it is assumed that the fluid reactive force for the i^{th} category cannot be calculated, so the threshold value evaluation is not performed.

In this way, in the reference example, those data that deviate greatly from the characteristic III that represents the steady-state input/output relationship, when operating properly, during processing operations are eliminated, and the fault check of the regulator valve 200 is performed accurately using the simple steady-state model.

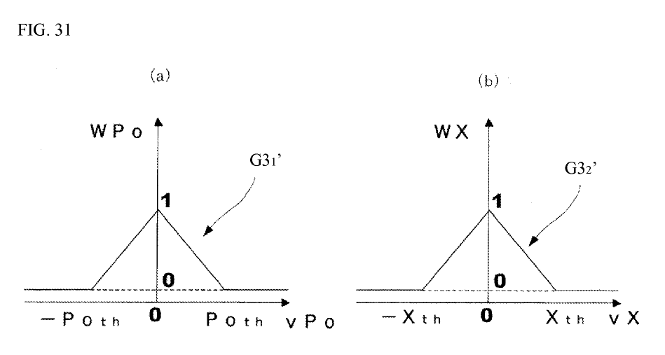

Note that while in the reference example weighting functions G3₁ and G3₂ were used for calculating weightings according to the combinations of the speed of change of the operating device pressure Po and the speed of change of the degree of opening X, where rectangular weighting functions such as shown in FIG. 21 (a) and (b) were used, a triangular weighting function such as shown in FIG. 31 (a) and (b) may be used instead.

In the weighting function G3₁′, shown in FIG. 31 (a), if vPo is 0, then wPo is set to 1, but in the range wherein the absolute value of vPo is no greater than the threshold value Poth, instead wPo may gradually grow larger toward vPo=0, where otherwise wPo is 0. In the weighting function G3₂′ shown in FIG. 31 (b), wX is 1 if vX is 0, wherein a range wherein the absolute value of vX is no larger than the threshold value Xth, wX may gradually grow larger towards vX=0, and wX is 0 otherwise.

Moreover, instead, in the weighting function G3₁′, for example, illustrated in FIG. 31 (a), wPo may be made larger as vPo gradually approaches vPo=0 from positions that are further separated in the positive direction or negative direction, and in the weighting function G3₂′ illustrated in FIG. 31 (b), wX may be made gradually larger as vX approaches vX=0 from positions that are further separated in the positive direction or the negative direction.

Moreover, the weighting function for calculating the weighting depending on the combination of the speed of change of the operating device pressure Po and the speed of change of the degree of opening X need not necessarily be divided into weighting functions G3₁ and G3₂, but rather may be a single weighting function that combines G3₁ and G3₂ (a three-dimensional function). The same is true for the triangular weighting functions G3₁′ and G3₂′, which may be a single weighting function combining G3₁′ and G3₂′ (a three-dimensional function).

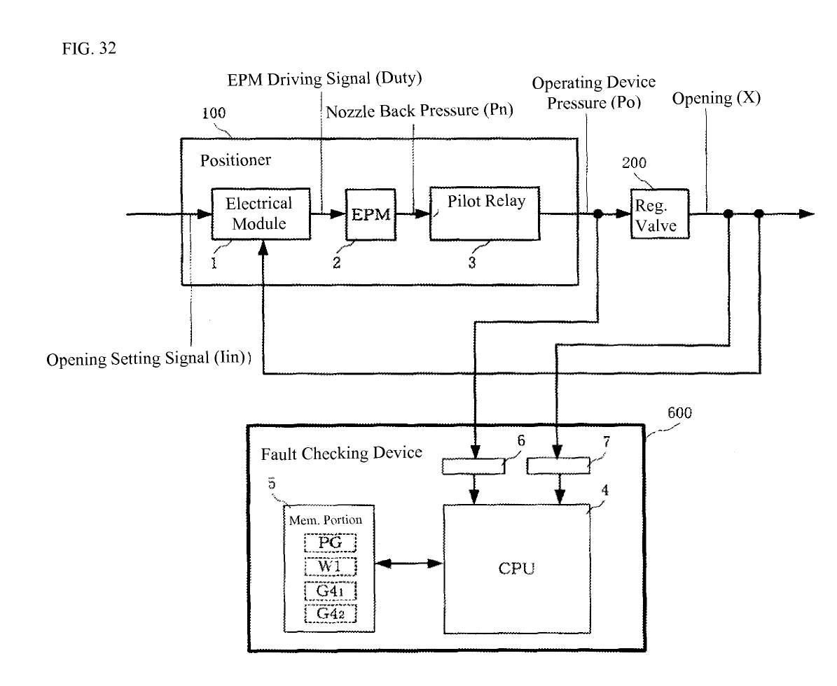

Another reference example is described below. FIG. 32 shows the structure of components of a fault checking device 600 for performing fault checking for a regulator valve 200 using a value for the hysteresis width as the fault check indicator value. In the fault checking device 600 as well, as with the above reference example, a CPU 4, a memory portion 5, such as a ROM or a RAM, and interfaces 6 and 7 are provided.

The operating device pressure Po that is the input signal into the regulator valve 200 is branched and inputted through the interface 6 into the CPU 4, and the degree of opening X, which is the output from the regulator valve 200, is branched and inputted through the interface 7 into the CPU 4. The CPU 4 operates in accordance with a program PG that is stored in the memory portion 5.

In addition to the program PG referenced above, a hysteresis width W1 in the characteristic (the hysteresis characteristics of the operating device pressure Po and the degree of opening X) that represents the input/output relationship, when operating properly, of the regulator valve 200, and weighting functions G4₁ and G4₂, for calculating weightings in accordance with combinations of the speed of change of the operating device pressure Po and the speed of change of the degree of opening X, are stored in the memory portion 5.

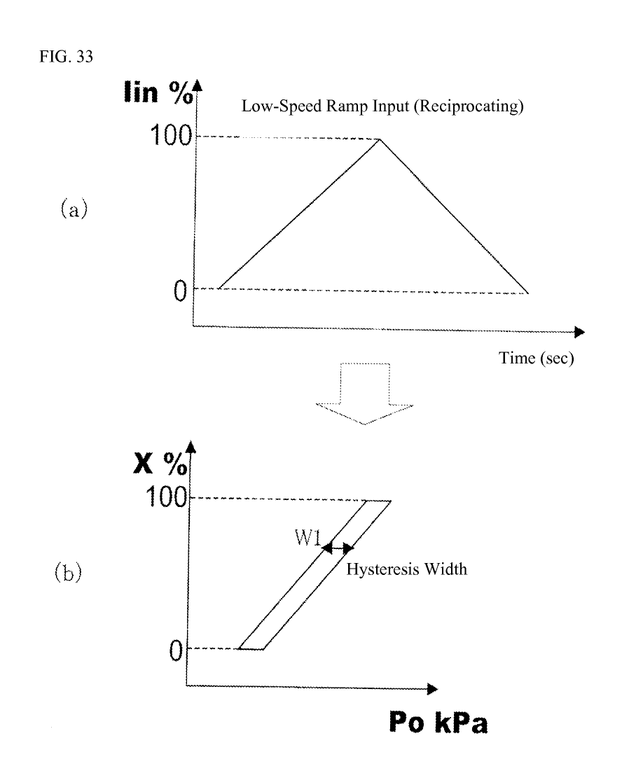

In this reference example, the hysteresis width W1 when the regulator valve 200 is operating properly is calculated from the design specification of the regulator valve 200 and stored in the memory portion 5. Note that if there is no design specification for the regulator valve 200, then, when in a proper operating state, such as immediately following maintenance, a low-speed ramped input may be applied to the positioner 100, reciprocating over the entire opening range thereof, as illustrated in FIG. 33 (a), to obtain data for the operating device pressure Po and the opening X, as shown in FIG. 33 (b), and the hysteresis width W1, when operating properly, may be calculated from the result.

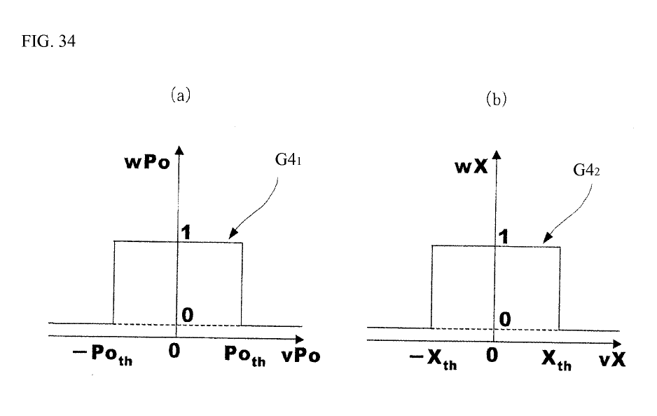

In the present reference example, the weighting functions G4₁ and G4₂, as illustrated in FIG. 34 (a) and (b), are the same as those of the weighting functions G3₁ and G3₂ described in the above reference example (FIG. 21 (a) and (b)), so explanations are omitted here.

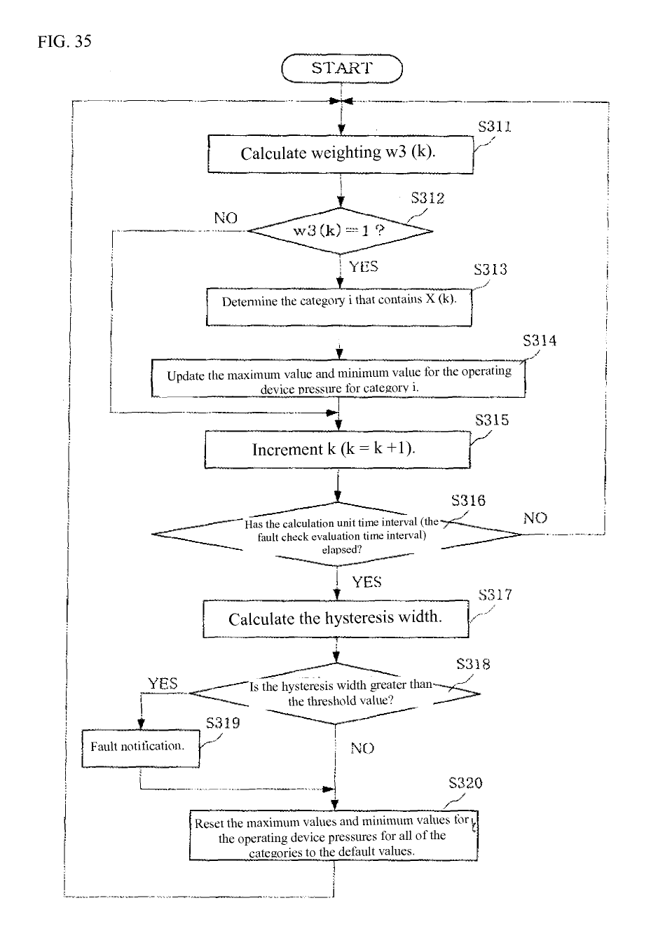

Fault checks during processing operations are described below. During processing operations, the CPU 4 periodically reads in the operating device pressure Po that is inputted into the regulator valve 200 and the degree of opening X that is outputted from the regulator valve 200, to perform the fault checking on the regulator valve 200. FIG. 35 shows a main flowchart for the fault checking process that is performed by the CPU 4.

In this flowchart, the procedures in Step S311 through S316 are the same as the procedures in Step S301 through S306 explained in the above reference example (FIG. 22), and thus are omitted here.

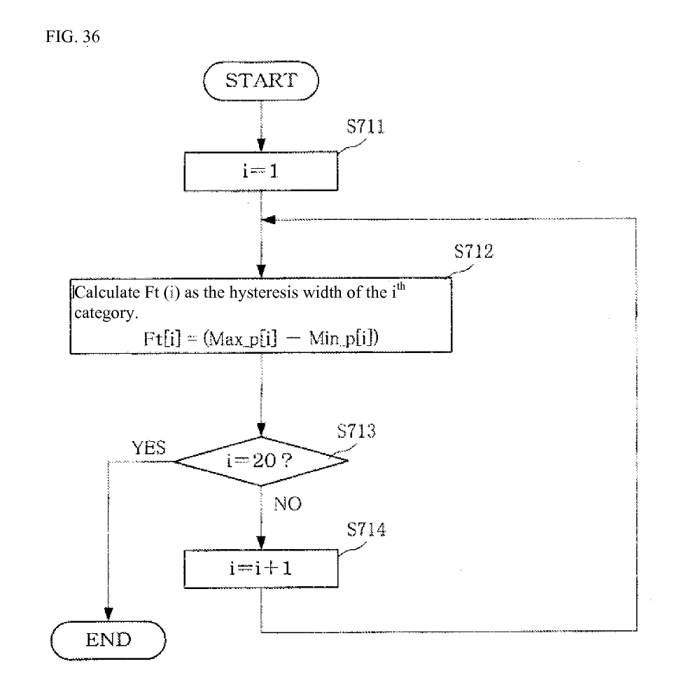

When the fault check evaluation time interval has expired (Step S316: YES), then the CPU 4 calculates the hysteresis width in each category i as a fault check indicator value (Step S317). FIG. 36 shows the subroutine for the process that is performed in Step S317.

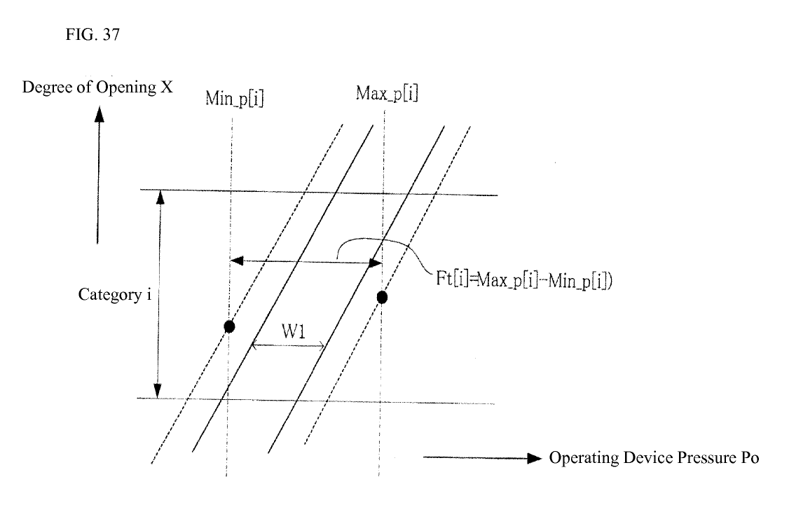

The CPU 4 first sets i=1 (Step S711). Given this, with Ft (i) defined as the hysteresis width for the i=1 category, the maximum value Max_p (i) and the minimum value Min_p (i) for the operating device pressure Po in that category i are substituted into Equation (13), below, to calculate the hysteresis width Ft (i) for the i=1 category (Step S712, see FIG. 37).

Ft(i)=Max_{—}p(i)−Min_{—}p(i) (13)

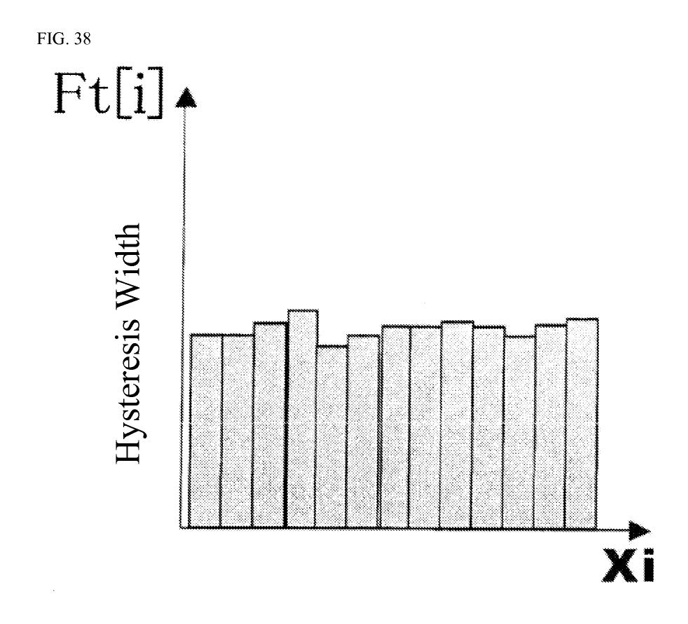

After calculating the hysteresis width Ft (i) for category i=1, the CPU 4 repeats the processing procedures of Step S711 through S714 while incrementing i (Step S714) until i reaches 20 (Step S713: YES). Doing so causes the hysteresis width Ft(i) for category i to be calculated for each of the categories i (referencing FIG. 38).

Additionally, after calculating the hysteresis width Ft (i) for each category i, the CPU 4 then reads in the hysteresis width W1 for the time of normal operation, stored in the memory portion 5, and uses as a threshold value a value wherein a specific value α has been added to this hysteresis width W1 to compare the hysteresis widths Ft (i) to this threshold values (Step S318 (FIG. 35)), and if even one of the flow hysteresis widths Ft (i) exceeds a threshold value (Step S318: YES), provides a fault notification (Step S319).

After the fault notification of Step S319, or in response to NO in Step S308, the CPU 4 resets all of the maximum values Max_p (i) and minimum values Min_p (i) for the operating device pressures Po in all of the categories i to the default values (Step S320), returns to the procedure of Step S301, and repeats the same operating procedures. The resetting to the default values in Step S320 is the same as the operating procedure in Step S310 in the previous reference example (FIG. 22 (FIG. 27)), so the explanation thereof can be omitted here.

In this way, in the present reference example, those data that deviate greatly from the hysteresis width, when operating properly, during processing operations are eliminated, and the fault check of the regulator valve 200 is performed accurately using the hysteresis width.

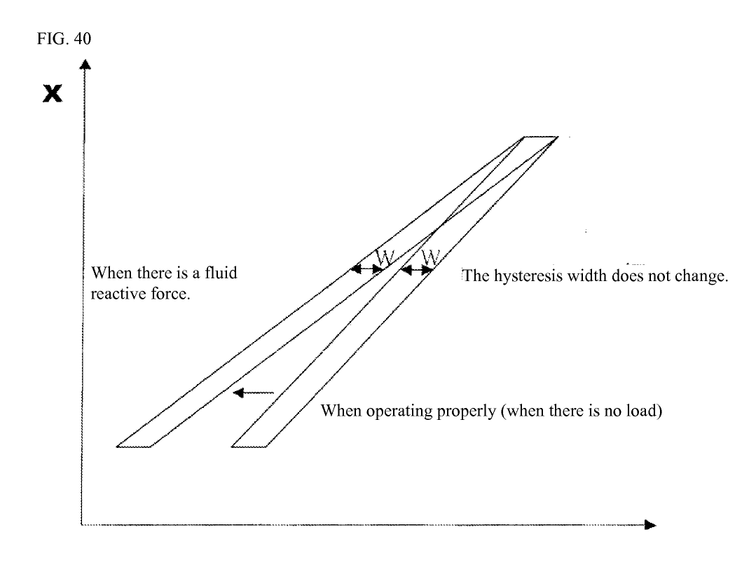

Note that as shown in the previous reference example, the valve shaft is affected by the fluid reactive force during operation, changing the relationship between the operating device pressure Po and the degree of opening X. However, the hysteresis width W is dependent on the frictional force, and, as shown in FIG. 40, is not changed greatly by the fluid reactive force. Because of this, the present reference example does not cease to be effective even under the influence of the fluid reactive force.

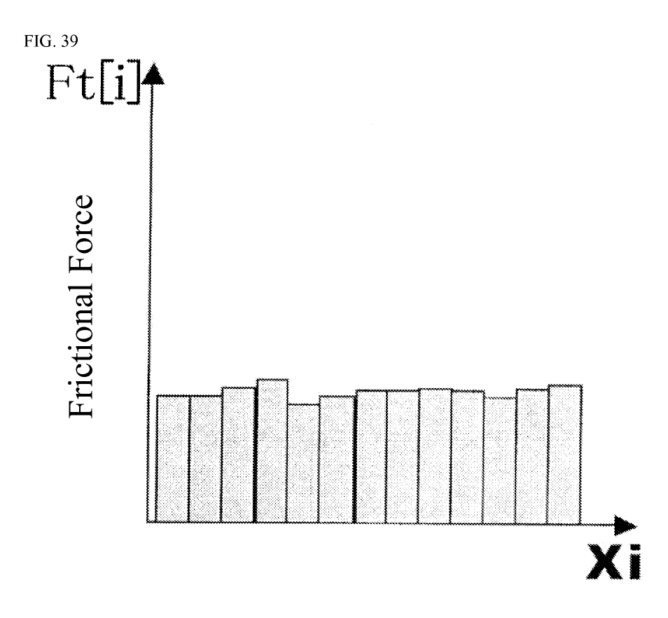

Moreover, while in the other reference example the hysteresis width was calculated for each category i as Ft (i)=Max_p (i)−Min_p (i) in Step S317, the frictional force may be calculated for each category i as Ft (i)=(Max_p (i)−Min_p (i))/2. (See FIG. 39.)

If the frictional force is used for Ft (i), that, in Step S318, the hysteresis width W1 for the time of proper operation, which is stored in the memory portion 5, may be read out, a half value for this hysteresis width W1 (W1/2) may be calculated, and a value where this half value (W1/2) of the hysteresis width W1 is added by a specific value 0 may be used as the threshold value, where this threshold value may be compared to the frictional force Ft (i). Conversely, the half value (W1/2) of the hysteresis width W1 when operating properly may be stored in the memory portion 5, and a value where this half value (W1/2) of the hysteresis width W1 is added by a specific value β may be used as the threshold value, where this threshold value may be compared to the frictional force Ft (i). While in this case Ft (i) is a pressure (kPa), the units can be converted from a pressure (kPa) into a force (N) through multiplying by the surface area of the diaphragm of the operating device (m²)×10⁻³.

Moreover, while in reference example set forth above the explanation was for performing fault checking on a regulator valve 200, instead fault checking may be performed in the same manner as described above, when the entire system wherein a positioner and a regulator valve are combined is considered to be a single regulator valve. In this case, the opening setting signal Iin that is the input signal into the positioner 100 would correspond to an input signal into the regulator valve, and the fault checking for the system as a whole (the regulator valve) would use this opening setting signal Iin and the degree of opening X.

Moreover, even in the examples set forth above, the hysteresis width W may be calculated in the same manner as in the reference examples, and fault checking may be performed for the EPM 2 and the pilot relay 3 using this hysteresis width W as the fault check indicator value.

The positioner fault checking method and device according to the present invention may be used in fault checking of modules such as EPMs and pilot relays within positioners, as a method for checking for faults in a positioner that controls the opening of a regulator valve.

We claim:

1. A positioner fault checking method for performing fault checking on an applicable module wherein a specific module within a positioner that controls the opening of a regulator valve is the applicable module, comprising the steps of:
sampling periodically an input signal into the applicable module and an output signal from the applicable module;
calculating a speed of change of the input signal that has been sampled;
calculating a speed of change of the output signal that has been sampled;
calculating a weighting depending on a combination of the speed of change of the input signal and the speed of change of the output signal, based on a weighting function that has been established in advance; and
performing fault checking of the applicable module based on the input signal and the output signal that have been sampled and on the weighting that has been calculated.

2. The positioner fault checking method as set forth in claim 1, wherein the step for performing the fault checking comprises the steps of:
calculates a fault check indicator value, to be used in fault checking of the applicable module, from the input signal and the output signal that have been sampled, the weighting that has been calculated, and a steady-state input/output relationship of the applicable module when operating properly.

3. The positioner fault checking method as set forth in claim 1, wherein:
the weighting function is a function wherein the weighting is large when the speed of change of the input signal and the speed of change of the output signal are small.

4. The positioner fault checking method as set forth in claim 1, wherein:
the weighting function is a function wherein the weighting is large when the absolute values of the speed of change of the input signal and the speed of change of the output signal are in ranges that are less than threshold values.

5. The positioner fault checking method as set forth in claim 1, wherein:
the applicable module is an electro-pneumatic converting device;
the input signal is a duty signal; and
the output signal is a nozzle back pressure.

6. The positioner fault checking method as set forth in claim 1, wherein:
the applicable module is a pilot relay device;
the input signal is a nozzle back pressure; and
the output signal is an operating device pressure.
